(19) United States
(12) Patent Application Publication
(10) Pub. No.: US 2005/0074701 A1
(43) Pub. Date: Apr. 7, 2005

(54) Method for manufacturing optical disk master and method for manufacturing optical disk

(75) Inventors: Masahiko Tsukuda, Suita-shi (JP); Shinya Abe, Kadoma-shi (JP); Eiichi Ito, Nishinomiya-shi (JP); Morio Tomiyama, Ikoma-shi (JP)

Correspondence Address: POWERDSINE LTD.;C/O LANDON STAK CANTWELL & PAXTON, ONE CRYSTAL PARK, SUITE 210, 2011 CRYSTAL DRIVE, ARLINGTON,, VA, 22202-3709, US

(73) Assignee: MATSUSHITA ELECTRIC INDUSTRIAL CO., LTD., Kadoma-shi (JP)

(21) Appl. No.: 10/409,487

(22) Filed: Apr. 8, 2003

(30) Foreign Application Priority Data
Apr. 9, 2002 (JP) 2002-106169
Jul. 9, 2002 (JP) 2002-200518

(51) Int. Cl. G11B 7/24; B29D 17/00

(52) U.S. Cl. 430/320; 430/321; 430/945; 430/330; 264/1.33; 369/275.4; 369/275.3

(57) ABSTRACT

A method for manufacturing an optical disk master includes: forming a resist layer by the application of a chemically amplified resist; converting an information signal into a multipulse signal having a symmetrical shape; exposing the resist layer in accordance with the multipulse signal; heat-treating the resist layer; and developing the resist layer to form signal pits. The signal pits are exposed to the multipulse signal, which is obtained by dividing a pulse into symmetrical pulses, thereby adjusting the exposure area and achieving a desired pit shape.

### BACKGROUND OF THE INVENTION

1. Field of the Invention

The present invention relates to a method for manufacturing an optical disk master that uses a chemically amplified resist for recording, and an optical disk produced by the optical disk master and a method for manufacturing the optical disk. In particular, the present invention relates to a method for manufacturing a high-density optical disk master, and an optical disk and a method for manufacturing the optical disk.

2. Description of the Related Art

A conventional method for manufacturing an optical disk includes: producing an optical disk master having a concave/convex pattern of information pits or grooves by exposing and developing a photoresist-coated master in an optical disk master recording apparatus that uses a laser or electron beam as a light source; producing a metal mold (stamper) by transferring the pattern of the optical disk master; producing a molded resin substrate by using the stamper; and forming or bonding a recording film, a reflective film, etc. on the molded resin substrate (see, e.g., JP 6(1994)-295440 A).

With the recent progress in high-density optical disks, the wavelength of a light source for an optical disk master recording apparatus has become increasingly shorter. There is also a growing demand for electron beam recording of some high-density disks under development. The following is an example of the electron beam recording.

FIG. 2 shows the general configuration of an electron beam recording apparatus used for exposure in the production process of an optical disk master. The electron beam recording apparatus includes an electron beam source for generating an electron beam and an electron optical system for converging the emitted electron beam on a resist master so that an information pattern is recorded on the resist master in response to an information signal.

The electron beam source includes a filament 201, a suppressor electrode 202, and an extractor electrode 203. The filament 201 passes a current to emit electrons. The suppressor electrode 202 entraps the electrons emitted from the filament 201. The extractor electrode 203 extracts an electron beam from a pinhole provided in the suppressor electrode 202 and accelerates the electron beam.

The electron optical system includes the following: a lens 204 for converging an electron beam; an aperture 205 for determining a beam diameter of the electron beam; an electrode 206 for deflecting the electron beam in a desired direction according to an information signal; a shielding plate 207; a lens 208 for converging the electron beam on the surface of a resist master 210; and a correction electrode 209 for correcting aberration of the electron beam. The resist master 210 is fixed to a turntable 211 and can be moved with the turntable 211 by a slider 212. Depending on an information signal 213 supplied to the electrode 206, the traveling direction of the electron beam is directed to the resist master 210 or deflected toward the shielding plate 207 so that the resist master 210 is not exposed to the electron beam.

The electron beam is converged on the center of the electrode 206 by the lens 204 and on the resist master 210 by the lens 208. Therefore, even if the traveling direction of the electron beam is changed by the application of a voltage to the electrode 206, it does not affect the irradiation position on the resist master 210.

FIG. 3 shows a signal that is input to the electrode 206 as the information signal 213. To record pits 304 having a desired length, a pulse 301 whose length is determined in accordance with the linear velocity of the rotating resist master is used as the information signal. A signal 302 is input to the electrode 206. When the signal 302 is not less than a threshold voltage 303, the electrode 206 does not deflect the electron beam, and the resist master is irradiated with the electron beam. When the signal 302 is not more than the threshold voltage 303, the electrode 206 deflects the electron beam toward the shielding plate 207, and the resist master is shielded from the electron beam.

A resist made of a photosensitive material for electron beam exposure generally is used as a photoresist for the electron beam recording, though a resist for a far ultraviolet laser also can be used. The electron beam resist having a desired thickness is applied to a master (e.g., a silicon wafer), and the master is exposed and recorded in the electron beam recording apparatus as shown in FIG. 2.

The exposed master is developed to form a concave/convex pattern of information pits or grooves. A thin film made of a conductive material such as nickel is formed on the patterned resist master by sputtering or the like, which then is plated by using the thin film as an electrode, thus producing a metal mold for resin molding, i.e., a stamper. The stamper is used to form a resin substrate by injection molding or the like, so that the pattern is transferred to the resin substrate. Then, films are formed or bonded on the resin substrate to complete an optical disk.

A conventional electron beam resist used for the electron beam recording satisfactorily can reproduce the shape of an electron beam. However, the exposure sensitivity of the electron beam resist is low. Therefore, the electron beam irradiation per unit area of the resist surface should be increased considerably to form, e.g., a desired pit pattern for a next-generation read-only DVD with a storage capacity of 20 GB or more. Generally, the amount of electron beam should be at least ten times that required for an electron microscope or the like. In the electron beam recording apparatus, the electron beam irradiation per unit area of the resist surface is increased, e.g., by applying a larger voltage to the extractor electrode to extract as many electrons as possible. Alternatively, the recording linear velocity is lowered by reducing the rotation speed of the resist master without changing the amount of electron beam to be extracted (i.e., the amount of electron beam falling on the resist surface), so that the electron beam irradiation per unit area can be increased relatively. However, the application of a larger voltage to the extractor electrode leads to a high possibility of anomalous discharge etc. in the electron beam source and interferes with the stable operation of the apparatus. Moreover, a decrease in recording linear velocity makes the exposure time longer and results in poor productivity. Therefore, this is not suitable for the mass production of optical disks. The longer the exposure time is, the more likely the state of an exposed portion in the same master varies with time due to deterioration of the resist material or the like. Accordingly, the recording reproducibility also may be degraded. Some conventional electron beam resists require a special solvent as a developer. In many cases, therefore, a developing apparatus for a novolac resist that has been used in a laser recording apparatus is not available.

As a photoresist for the electron beam recording, a chemically amplified resist may be used instead of a conventional electron beam resist. The chemically amplified resist can be applied to an electron beam or short wavelength laser such as a far ultraviolet laser. Compared with a conventional resist, the chemically amplified resist has higher exposure sensitivity and requires less electron beam irradiation per unit area. These characteristics can reduce a burden on the electron beam recording apparatus, increase the recording linear velocity, and enhance the productivity.

In the chemically amplified resist, a portion irradiated with an electron beam generates acids that can function as a catalyst to promote a resist reaction by post-exposure bake (PEB). During PEB, the acids diffuse from the exposed portion into the peripheral portion, and the resist reaction is made to take place. Therefore, the shape of a pattern formed by development does not correspond to the exposed portion, but extends from the exposed portion to the peripheral portion in accordance with the acid diffusion.

When the resist master is irradiated with an electron beam by using an information pattern to record one pit for one pulse as shown in FIG. 3, the total amount of acid generated by the exposure to a short pulse pattern for forming a short pit differs significantly from that generated by the exposure to a long pulse pattern for forming a long pit. Such a difference in the total amount of acid between the exposed portions of the short pit and the long pit leads to a difference in the amount of acid diffusion by PEB. The amount of acid diffusion in the exposed portion of the long pit is larger than that in the exposed portion of the short pit. Consequently, when this resist master is developed to form a concave/convex pattern after PEB, the long pit is further increased in size relative to the short pit. Moreover, both the length and width of the pits deviate from the intended values. In the case of a PWM signal that recognizes a pit length as information, the deviation of the pit length from the intended value degrades signal jitter properties. Therefore, when the chemically amplified resist is used, a PEB temperature generally is set so that the amount of acid diffusion is not excessively large. This temperature is referred to as “standard specification temperature” in the following. At the standard specification temperature, however, the acid diffusion is not uniform, and pit shape variations or edge distortion tend to occur. Thus, it is difficult to achieve reproducibility in forming the same pattern of pits.

For a multilayer disk produced by the repetition of transfer to a UV curable resin, a first substrate having pits is prepared by injection molding, a reflective film is formed on the pits of the first substrate by sputtering, and a first information layer, which is located farthest from reproduction light, is deposited on the reflective film. Therefore, the pits of the first information layer are made smaller than those of the first substrate due to the presence of the reflective film.

Moreover, transfer pits formed by a transfer process tend to be smaller than the pits of a transfer stamper due to the transfer characteristics of a UV resin or the like. Particularly, a short pit significantly is reduced in size. This may result in a poor balance of pit width etc. between the short pit and the long pit.

### SUMMARY OF THE INVENTION

Therefore, with the foregoing in mind, it is an object of the present invention to record a desired pit pattern by using a chemically amplified resist so as to improve the productivity, reduce a burden on an electron beam recording apparatus, and ensure the reproducibility of a pit shape.

It is another object of the present invention to optimize a pit shape of a transfer information surface of a transfer stamper so as to achieve the optimum shape of a transfer pit or to optimize a pit shape of a substrate so as to achieve substantially the same pit shape of each layer in a multilayer disk.

A method for manufacturing an optical disk master of the present invention includes: forming a resist master by the application of a chemically amplified resist; converting an information signal into a multipulse signal having a symmetrical shape; exposing the resist master in accordance with the multipulse signal; heat-treating the exposed resist master; and developing the resist master to form signal pits.

A method for manufacturing an optical disk of the present invention includes: forming a transfer stamper having a transfer information surface on at least one side, the transfer information surface being formed of a signal layer including at least concave pits; bonding a base substrate and the transfer stamper together so that the transfer information surface is opposed to the base substrate with a photocurable resin in contact with the transfer information surface; and transferring the transfer information surface of the transfer stamper to the photocurable resin while removing the transfer stamper at the interface with the photocurable resin. The transfer stamper is formed so that the width of each pit of a transferred information surface is substantially the same. In this specification, “substantially the same” indicates that a permissible deviation from a predetermined value is in the range of ±5%.

### BRIEF DESCRIPTION OF THE DRAWINGS

FIG. 1 shows a multipulse signal pattern and a pit shape according to Embodiment 1 of the present invention.

FIG. 2 is a schematic diagram showing an example of a conventional electron beam recording apparatus.

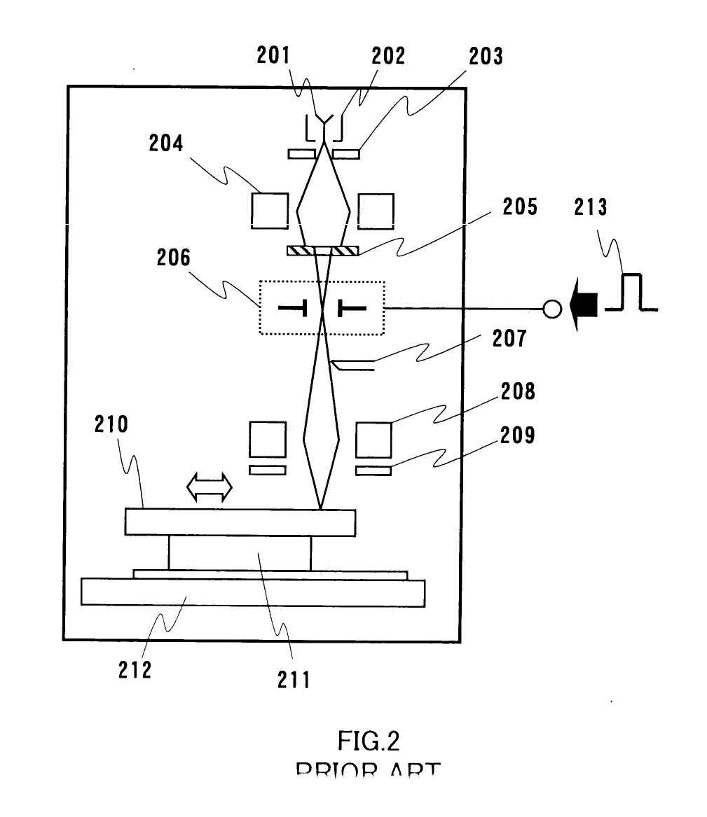

FIG. 3 is a schematic diagram showing a conventional information signal pattern and a pit shape.

FIG. 4 is a schematic diagram showing an electron beam recording apparatus according to Embodiments 1 to 6 of the present invention.

FIG. 5 shows the relationship between a PEB temperature and the amount of acid diffusion according to Embodiment 1 of the present invention.

FIG. 6 shows a PEB process at a temperature of not less than the standard specification temperature using a conventional information signal pattern.

FIG. 7 shows a multipulse signal pattern of a 3T signal and a pit shape according to Embodiment 2 of the present invention.

FIG. 8 shows the relationship between a front (rear) pulse width and asymmetry according to Embodiment 1 of the present invention.

FIG. 9 shows a multipulse signal pattern and a pit shape according to Embodiment 1 of the present invention.

FIG. 10 shows a difference in pit shape between the standard specification temperature and a temperature higher than the standard specification temperature.

FIG. 11 shows a signal pattern and a pit shape according to Embodiment 3 of the present invention.

FIG. 12 shows a PEB process at a temperature of not less than the standard specification temperature using a conventional information signal pattern.

FIG. 13 is a schematic cross-sectional view showing a two-layer disk according to Embodiment 4 of the present invention.

FIG. 14 shows the relationship between the thickness of a first reflective film and the jitter value of a reproduced signal according to Embodiment 4 of the present invention.

FIG. 15 shows the relationship between the thickness of a first reflective film and the rate of change in pit width of a first substrate before and after the formation of the first reflective film according to Embodiment 4 of the present invention.

FIG. 16 shows a PEB process at a temperature of not less than the standard specification temperature using a conventional information signal pattern.

FIG. 17 shows a multipulse signal pattern and a transfer pit shape according to Embodiment 4 of the present invention.

FIG. 18 shows the relationship between the widths of a front pulse and a rear pulse and the asymmetry of a 3T signal according to Embodiment 4 of the present invention.

FIG. 19 shows a multipulse signal pattern and a pit shape according to Embodiment 4 of the present invention.

FIG. 20 shows a multipulse signal pattern and a transfer pit shape according to Embodiment 5 of the present invention.

FIG. 21 shows a signal pattern and a pit shape according to Embodiment 6 of the present invention.

FIG. 22 is a schematic cross-sectional view showing a two-layer disk according to Embodiment 7 of the present invention.

FIGS. 23A to 23D are cross-sectional views showing an example of a method for manufacturing a multilayer disk according to Embodiments 4 and 8 of the present invention.

FIG. 24 shows an example of an optical disk that includes transfer pits according to Embodiment 8 of the present invention.

FIG. 25 shows an example of an optical disk that includes transfer pits according to Embodiment 8 of the present invention.

FIG. 26 shows an example of an optical disk that includes transfer pits according to Embodiment 8 of the present invention.

### DESCRIPTION OF THE PREFERRED EMBODIMENTS

To ensure the reproducibility of a pit shape or to improve an edge shape, the present invention uses a PEB temperature of not less than the standard specification temperature so that the amount of acid diffusion is increased sufficiently. However, a larger amount of acid diffusion causes the deviation of both length and width from the intended shape for pits having different lengths. For a conventional technique, each of the pits having different lengths is exposed to one pulse with a predetermined length. In contrast, the present invention divides the pulse into a plurality of pulses to provide a multipulse signal. The use of the multipulse signal in exposure makes it possible to adjust the exposure area and to form the intended pit shape. Particularly, a desired pit shape can be achieved with a multipulse signal pattern having a symmetrical shape.

When a multilayer disk is produced, the transfer pits formed by transfer to a UV curable resin may not have a good balance in pit length. To avoid this, the present invention uses the multipulse signal to optimize recording for the formation of a transfer stamper so that the transfer pits are balanced.

The pits of a first substrate are made smaller due to the presence of a reflective film, and the size of the transfer pits is changed from that of the pits of the transfer stamper due to the transfer characteristics of a UV curable resin or the like. To solve these problems, the present invention uses the multipulse signal to optimize the pit shape of the transfer stamper so that the pits of each layer are the same in shape, but different in size.

The multipulse signal may include the following: one pulse for a first pit that is the shortest pit of the signal pits; two pulses for a second pit that is the second shortest pit, the two pulses including a front pulse and a rear pulse that have substantially the same length; three pulses for a third pit that is the third shortest pit, the three pulses including a front end pulse, a rear end pulse, and an intermediate pulse arranged between the front end pulse and the rear end pulse, the front end pulse and the rear end pulse having substantially the same length, and the intermediate pulse having the same cycle as that of a clock signal of the information signal; and pulses for the pits more than the third pit, in which the number of intermediate pulses is increased one by one.

The first pit may be a 2T pit.

The pulse width of the front pulse and the rear pulse may be 60% to 130% of a pulse that corresponds to the first pit.

The pulse width of the front end pulse and the rear end pulse may be 40% to 130% of a pulse that corresponds to the first pit.

The pulse width of the front pulse and the rear pulse may be 60% to 130% of a pulse that corresponds to the first pit, and the pulse width of the front end pulse and the rear end pulse may be 40% to 130% of the pulse that corresponds to the first pit.

The first pit may be a 3T pit.

The pulse width of the front pulse and the rear pulse may be 60% to 80% of a pulse that corresponds to the first pit.

The pulse width of the front end pulse and the rear end pulse may be 40% to 100% of a pulse that corresponds to the first pit.

The pulse width of the front pulse and the rear pulse may be 60% to 80% of a pulse that corresponds to the first pit, and the pulse width of the front end pulse and the rear end pulse may be 40% to 100% of the pulse that corresponds to the first pit.

The multipulse signal may include the following: one pulse for a first pit that is the shortest pit of the signal pits; two pulses for a second pit that is the second shortest pit, the two pulses including a front pulse and a rear pulse that have substantially the same length; two pulses for a third pit that is the third shortest pit, the two pulses including a front end pulse and a rear end pulse that have substantially the same length; three pulses for a fourth pit that is the fourth shortest pit, the three pulses including a front end pulse, a rear end pulse, and an intermediate pulse arranged between the front end pulse and the rear end pulse, the front end pulse and the rear end pulse having substantially the same length, and the intermediate pulse having the same cycle as that of a clock signal of the information signal; and pulses for the pits more than the fourth pit, in which the number of intermediate pulses is increased one by one.

The first pit may be a 3T pit.

The pulse width of the front pulse and the rear pulse may be 60% to 80% of a pulse that corresponds to the first pit.

The pulse width of the front end pulse and the rear end pulse may be 90% to 110% of a pulse that corresponds to the first pit.

The pulse width of the front pulse and the rear pulse may be 60% to 80% of a pulse that corresponds to the first pit, and the pulse width of the front end pulse and the rear end pulse may be 90% to 110% of the pulse that corresponds to the first pit.

A duty ratio of the intermediate pulse may be 45% to 65%.

The output level of a spacing between the front pulse and the rear pulse or a spacing between the front end pulse and the rear end pulse may be not more than 50% of the maximum output of each pulse.

The positions of the front pulse and the rear pulse may be shifted backward and forward or forward and backward respectively by substantially the same amount so that the second pit has an optimum length.

The positions of the front end pulse and the rear end pulse may be shifted backward and forward or forward and backward respectively by substantially the same amount so that the signal pits more than the second pit have an optimum length.

The positions of the front pulse and the rear pulse may be shifted backward and forward or forward and backward respectively by substantially the same amount so that the second pit has an optimum length, and the positions of the front end pulse and the rear end pulse may be shifted backward and forward or forward and backward respectively by substantially the same amount so that the signal pits more than the second pit have an optimum length.

The exposed resist master may be heated at a temperature in the range of a thermosetting temperature to a thermal decomposition temperature of the resist. Moreover, an electron beam recording apparatus may be used for exposure and recording.

An example of a method for manufacturing an optical disk of the present invention is directed to a method for manufacturing a multilayer optical disk. The multilayer optical disk includes a first substrate and a signal layer formed on the first substrate with a transfer stamper. The signal layer is made of a resin substantially transparent to reproduction light. The first substrate has a first information surface on one side, and the first information surface is formed of a first signal layer including at least pits and a first reflective film. The method includes: forming at least one type of transfer stamper having a transfer information surface on at least one side, the transfer information surface being formed of a signal layer including pits; bonding the first substrate and the transfer information surface of the transfer stamper together with a UV curable resin in contact with the transfer information surface; and transferring the transfer information surface of the transfer stamper to the UV curable resin while removing the transfer stamper at the interface with the UV curable resin. When the transfer is performed at least one time by using the at least one type of transfer stamper on the first substrate, a pit shape of the first information surface is substantially the same as a pit shape of a transferred information surface.

Another preferred method is directed to a method for manufacturing a multilayer optical disk. The multilayer optical disk includes a first substrate, a signal layer formed on the first substrate with a transfer stamper, and a second substrate. The signal layer is made of a resin substantially transparent to reproduction light. The first substrate has a first information surface on one side, and the first information surface is formed of a first signal layer including at least pits and a first reflective film. The second substrate is made of a resin substantially transparent to reproduction light. The method includes: forming at least one type of transfer stamper having a transfer information surface on at least one side, the transfer information surface being formed of a signal layer including pits; bonding the second substrate and the transfer information surface of the transfer stamper together with a UV curable resin in contact with the transfer information surface; transferring the transfer information surface of the transfer stamper to the UV curable resin while removing the transfer stamper at the interface with the UV curable resin; and bonding a transferred information surface of the second substrate and the first information surface of the first substrate together with a resin substantially transparent to reproduction light after the transfer is performed at least one time by using the at least one type of transfer stamper on the second substrate. The transfer stamper is formed so that a pit shape of the first information surface is substantially the same as a pit shape of the transferred information surface.

The UV curable resin may have a viscosity of 40 mPa·s to 500 mPa·s. The first reflective film may have a thickness of 40 nm to 100 nm.

The width of pits except for the shortest pit of the transferred information surface may be 70% to 95% of the width of pits except for the shortest pit of the first signal layer formed on the first substrate.

The transfer stamper may be formed by using an optical disk master that is produced by: forming a resist master by the application of a chemically amplified resist; converting an information signal into a multipulse signal having a symmetrical shape; exposing the resist master in accordance with the multipulse signal; heat-treating the exposed resist master; and developing the resist master to form signal pits.

The multipulse signal may include the following: one pulse for a first pit that is the shortest pit of the signal pits; two pulses for a second pit that is the second shortest pit, the two pulses including a front pulse and a rear pulse that have substantially the same length; three pulses for a third pit that is the third shortest pit, the three pulses including a front end pulse, a rear end pulse, and an intermediate pulse arranged between the front end pulse and the rear end pulse, the front end pulse and the rear end pulse having substantially the same length, and the intermediate pulse having the same cycle as that of a clock signal of the information signal; and pulses for the pits more than the third pit, in which the number of intermediate pulses is increased one by one.

The first pit may be a 2T pit.

The pulse width of the front pulse and the rear pulse may be 50% to 100% of a pulse that corresponds to the first pit.

The pulse width of the front end pulse and the rear end pulse may be 40% to 110% of a pulse that corresponds to the first pit.

The pulse width of the front pulse and the rear pulse may be 50% to 100% of a pulse that corresponds to the first pit, and the pulse width of the front end pulse and the rear end pulse may be 40% to 110% of the pulse that corresponds to the first pit.

The first pit may be a 3T pit.

The pulse width of the front pulse and the rear pulse may be 50% to 80% of a pulse that corresponds to the first pit.

The pulse width of the front end pulse and the rear end pulse may be 40% to 100% of a pulse that corresponds to the first pit.

The pulse width of the front pulse and the rear pulse may be 50% to 80% of a pulse that corresponds to the first pit, and the pulse width of the front end pulse and the rear end pulse may be 40% to 100% of the pulse that corresponds to the first pit.

The multipulse signal may include the following: one pulse for a first pit that is the shortest pit of the signal pits; two pulses for a second pit that is the second shortest pit, the two pulses including a front pulse and a rear pulse that have substantially the same length; two pulses for a third pit that is the third shortest pit, the two pulses including a front end pulse and a rear end pulse that have substantially the same length; three pulses for a fourth pit that is the fourth shortest pit, the three pulses including a front end pulse, a rear end pulse, and an intermediate pulse arranged between the front end pulse and the rear end pulse, the front end pulse and the rear end pulse having substantially the same length, and the intermediate pulse having the same cycle as that of a clock signal of the information signal; and pulses for the pits more than the fourth pit, in which the number of intermediate pulses is increased one by one.

The first pit may be a 3T pit.

The pulse width of the front pulse and the rear pulse may be 50% to 80% of a pulse that corresponds to the first pit.

The pulse width of the front end pulse and the rear end pulse may be 70% to 110% of a pulse that corresponds to the first pit.

The pulse width of the front pulse and the rear pulse may be 50% to 80% of a pulse that corresponds to the first pit, and the pulse width of the front end pulse and the rear end pulse may be 70% to 110% of the pulse that corresponds to the first pit.

A duty ratio of the intermediate pulse may be 45% to 65%.

The output level of a spacing between the front pulse and the rear pulse or a spacing between the front end pulse and the rear end pulse may be not more than 50% of the maximum output of each pulse.

The positions of the front pulse and the rear pulse may be shifted backward and forward or forward and backward respectively by substantially the same amount so that the second pit has an optimum length.

The positions of the front end pulse and the rear end pulse may be shifted backward and forward or forward and backward respectively by substantially the same amount so that the signal pits more than the second pit have an optimum length.

The positions of the front pulse and the rear pulse may be shifted backward and forward or forward and backward respectively by substantially the same amount so that the second pit has an optimum length, and the positions of the front end pulse and the rear end pulse may be shifted backward and forward or forward and backward respectively by substantially the same amount so that the signal pits more than the second pit have an optimum length.

The exposed resist master may be heated at a temperature in the range of a thermosetting temperature to a thermal decomposition temperature of the resist.

The shortest pit of the signal pits of the first information surface and the pits of the transferred information surface may have a length of 0.1 μm to 0.3 μm.

The density of the first signal layer may be substantially the same as the density of the transferred information surface.

To ensure the reproducibility of a pit shape or to improve an edge shape with a chemically amplified resist, the present invention uses a PEB temperature of not less than the standard specification temperature so that the amount of acid diffusion is increased sufficiently. However, a larger amount of acid diffusion causes the deviation of both length and width from the intended shape for pits having different lengths. For a conventional technique, each of the pits having different lengths is exposed to one pulse with a predetermined length. In contrast, the present invention divides the pulse into a plurality of symmetrical pulses to provide a multipulse signal. The use of the multipulse signal in exposure makes it possible to adjust the exposure area and to form the intended pit shape.

Hereinafter, specific embodiments of the present invention will be described.

Embodiment 1

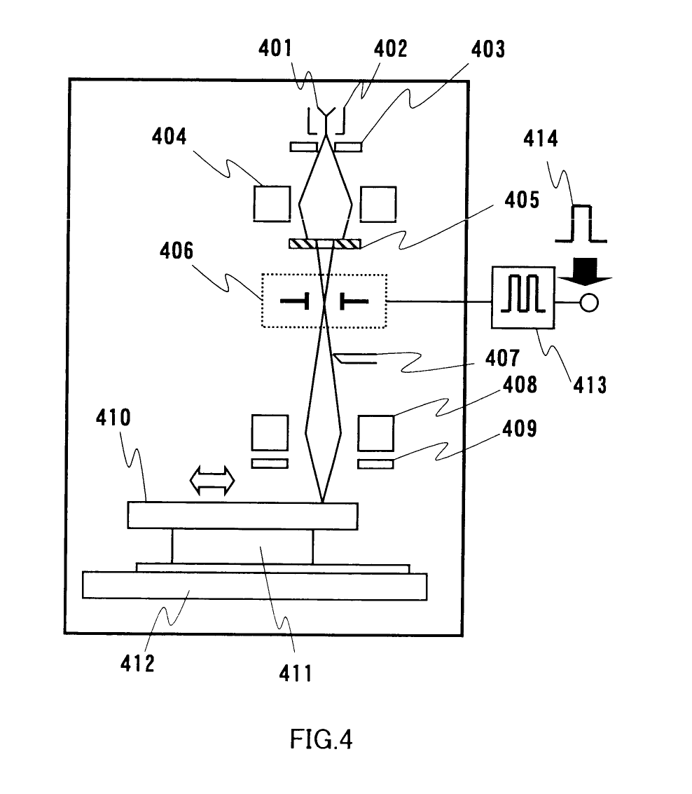

FIG. 4 is a schematic diagram of an electron beam recording apparatus used in Embodiment 1.

The electron beam recording apparatus includes an electron beam source for generating an electron beam and an electron optical system for converging the emitted electron beam on a resist master so that an information pattern is recorded on the resist master in response to an information signal.

The electron beam source includes a filament 401, a suppressor electrode 402, and an extractor electrode 403. The filament 401 passes a current to emit electrons. The suppressor electrode 402 entraps the electrons emitted from the filament 401. The extractor electrode 403 extracts an electron beam from a pinhole provided in the suppressor electrode 402 and accelerates the electron beam. A negative electrode is applied to the suppressor electrode 402 for the entrapment of electrons, and a positive electrode is applied to the extractor electrode 403. The electric field produced by the suppressor electrode 402 and the extractor electrode 403 causes the emission of electrons from the filament 401 (the electron beam source) to the electron optical system as an electron beam.

The electron beam emitted from the electron beam source enters the electron optical system. The electron optical system includes the following: a lens 404 for converging an electron beam; an aperture 405 for determining a beam diameter of the electron beam; an electrode 406 for deflecting the electron beam in a desired direction according to an information signal; a shielding plate 407; a lens 408 for converging the electron beam on the surface of a resist master 410; and a correction electrode 409 for correcting aberration of the electron beam. The resist master 410 is fixed to a turntable 411 and a slider 412 and moved in a predetermined direction while rotating at a desired speed, and thus information pits or grooves can be recorded on the resist master 410 in spiral fashion. The shielding plate 407 is arranged in contact with the edge portion of an electron beam that travels straight to the resist master 410 for irradiation. Depending on a signal supplied to the electrode 406, the traveling direction of the electron beam is directed to the resist master 410 or deflected toward the shielding plate 407 so that the resist master 410 is not exposed to the electron beam. Thus, the resist master 410 can be irradiated intermittently with the electron beam according to a signal pattern that is input to the electrode 406. The electron beam is converged on the center of the electrode 406 by the lens 404 and on the resist master 410 by the lens 408. Therefore, even if the traveling direction of the electron beam is changed by the application of a voltage to the electrode 406, it does not affect the irradiation position on the resist master 410.

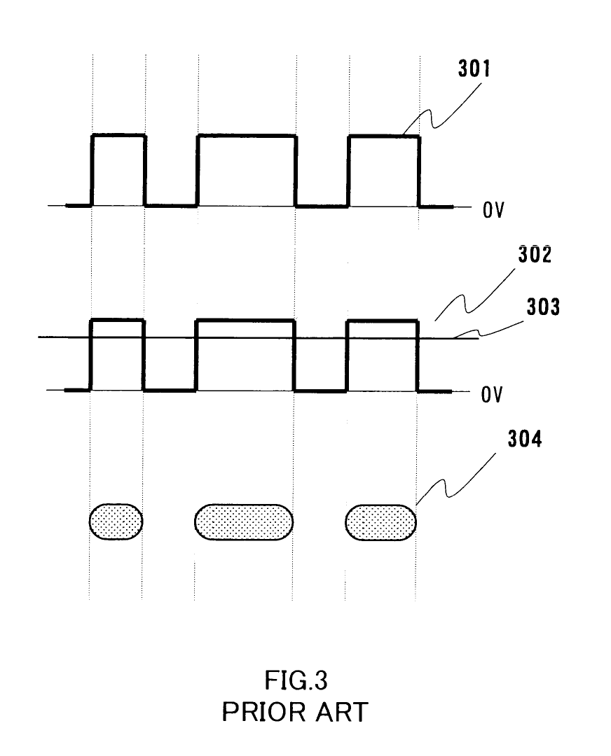

The signal pits of an optical disk are composed of various pit trains having a length that is an integral multiple of a signal clock cycle T. As shown in FIG. 3, a conventional signal input to the electrode 406 is a pulse train in which the length of each pulse is calculated by the recording linear velocity and corresponds to the length of each pit. To record a 2T pit whose length is two times longer than the clock cycle T, e.g., a signal pulse width L(2T) is given by L(2T) (ns)=PL(2T)/LV, where PL(2T) (nm) represents a desired pit length, and LV(m/s) represents a recording linear velocity. The resist master rotating at a linear velocity of LV is irradiated with an electron beam only for a time of L(2T). This equation can be applied to a long pit as well. One pulse having a length that is determined by the pit length and the recording linear velocity is input for each pit to the electrode 406. In contrast, an information signal 414 of Embodiment 1 is converted into a multipulse signal through a multipulse converter 413, and then is input to the electrode 406. The multipulse signal is obtained by dividing the pulse that is initially in one-to-one correspondence with a pit into symmetrical pulses.

A chemically amplified resist is a resist material in which acids generated in an exposed portion can function as a catalyst to promote a resist reaction while diffusing from the exposed portion into the peripheral portion by post-exposure bake (PEB). The individual chemically amplified resists have their own PEB temperature, which is referred to as “standard specification temperature.” For example, when a chemically amplified resist “UV3” manufactured by Shipley is applied to a silicon wafer, the standard specification temperature is 130° C.

The chemically amplified resist has been used generally for a semiconductor process. In the semiconductor process, the thickness of a resist applied to a master can be about ten times as large as the thickness of a resist used for an optical disk, and the master is exposed and recorded to form a uniform pattern in the resist thickness direction. Accordingly, the resist material is prepared to achieve such a uniform pattern, and the standard specification temperature is set in view of the semiconductor process. However, the pattern accuracy required for an optical disk should be different from that required for a semiconductor. At the standard specification temperature, acids generated in an exposed portion do not diffuse much, and the shape of the exposed portion can be reproduced. However, the pit edge often remains distorted. This is attributed to nonuniform acid diffusion caused by a small amount of acid diffusion. The edge distortion results in poor signal quality and cannot be tolerated for the purpose of an optical disk, even if it is permissible for the semiconductor process.

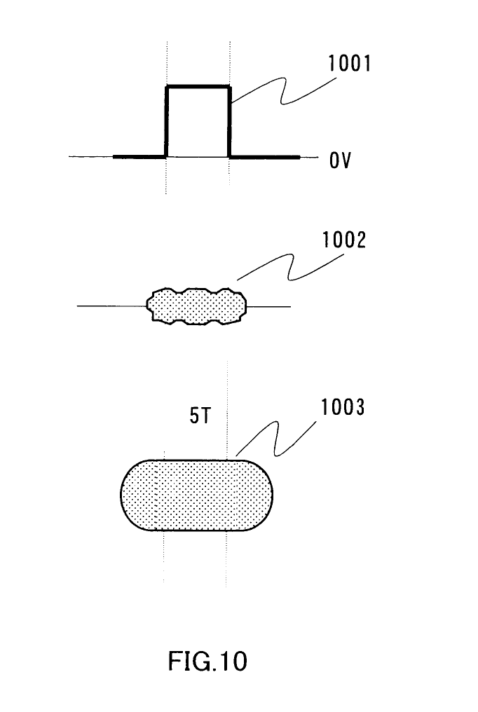

The present invention uses a PEB temperature of not less than the standard specification temperature. FIG. 10 schematically shows a pit shape at the standard specification temperature and a pit shape at a temperature about 20° C. higher than the standard specification temperature. Reference numeral 1001 denotes a pulse pattern used for exposure, 1002 denotes a pit shape at the standard specification temperature, and 1003 denotes a pit shape at a temperature about 20° C. higher than the standard specification temperature. As a PEB temperature is raised from the standard specification temperature, more acids that are generated in an exposed portion diffuse and improve the uniformity of diffusion. Therefore, the pit shape is made larger than the exposed portion, while the edge distortion can be eliminated. As with a higher PEB temperature than the standard specification temperature, a longer PEB time also may provide the same effect. In this case, however, the PEB temperature should be the standard specification temperature or higher.

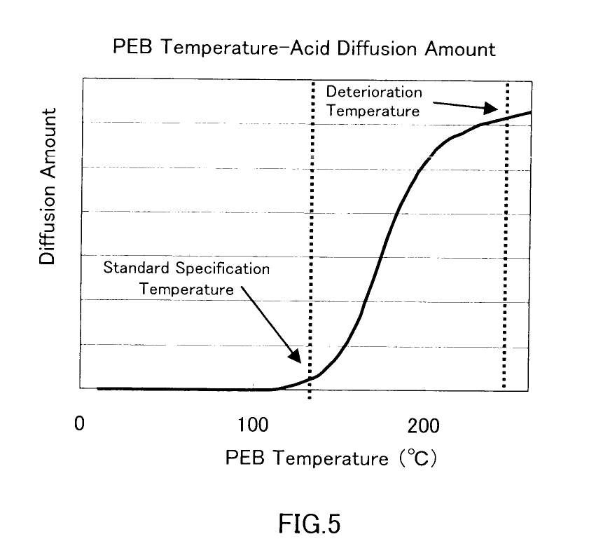

When the PEB temperature is raised excessively, the resist material deteriorates and loses its capability. This temperature is referred to as the “deterioration temperature” in the following. FIG. 5 is a graph showing the relationship between the PEB temperature and the amount of acid diffusion. By setting the PEB temperature in the range of the standard specification temperature to the deterioration temperature as shown in FIG. 5, a favorable pit edge shape can be achieved.

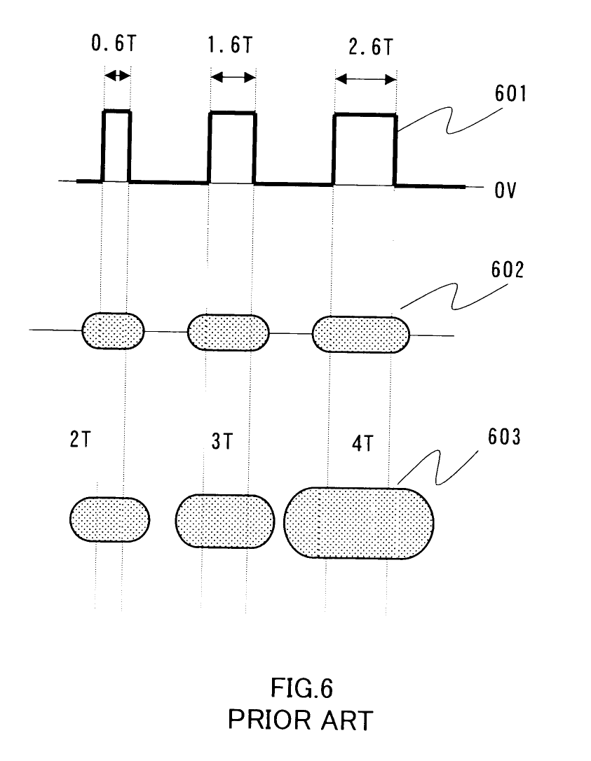

As shown in FIG. 6, when one signal pit is recorded for one pulse 601, the total amount of acid generated in the exposed portion of a short pit differs from that generated in the exposed portion of a long pit because of a difference in exposure area between the short pit and the long pit. The acids diffuse sufficiently at a PEB temperature in the range of the standard specification temperature to the deterioration temperature. Consequently, the resultant pits 603 differ significantly from the exposed portions 602 in both length and width and also deviate from a predetermined pit length and pit width.

Embodiment 1 provides a read-only DVD disk by using the electron beam recording apparatus in FIG. 4 and a chemically amplified resist. The DVD disk is reproduced by a blue-purple laser with a reproduction wavelength of about 400 nm and has a storage capacity of 20 GB or more. The modulation system is 1-7 PP modulation, the track pitch is 0.32 μm, and the length of a 2T pit (the shortest pit) is 0.149 μm. Here, T represents a clock cycle. In this embodiment, the 2T pit (the shortest pit) is referred to as a first pit, a 3T pit is referred to as a second pit, and further pits are referred to in the order of increasing pit length as a third pit and a fourth pit.

The chemically amplified resist is applied to a silicon wafer master in a thickness of about 100 nm. An optical disk master is produced at a recording linear velocity of 3 m/s. The resist master is exposed, post-exposure baked (PEB), and developed to form a concave/convex pattern on the surface. A nickel thin film is sputtered on the resist pattern, and then is plated to a thickness of about 0.3 mm by using the nickel thin film as an electrode. The resultant metal plate is separated from the resist master, cleaned to remove the resist material that adheres on the surface, and subjected to a drilling process. Using an injection molding machine, a resin is molded into a resin substrate. A reflective film and a protective layer are formed on the resin substrate, thus providing an optical disk.

When one signal pit is recorded for one pulse such as a signal 602 in FIG. 6, the actual exposure time to record the shortest pit (the first pit) 2T should be reduced by more than half the 2T, i.e., about 0.6T. The reason for this is as follows: when a PEB temperature is about 20° C. higher than the standard specification temperature (130° C.) of the chemically amplified resist used so as to improve the shape of a pit edge, the length of the 2T pit is about two or more times longer than that of the exposed portion due to acid diffusion. The evaluation of reproduction characteristics of a disk produced under these conditions shows that the asymmetry of a reproduced 2T signal is about 8%.

In this case, the length of the other pits increases for each addition of T to that of the 2T pit. The 3T pit and the 4T pit are formed by the exposure to a 1.6T pulse and a 2.6T pulse, respectively. The electron microscope observation of the pit shape shows that the width of the 3T pit is about 1.2 times that of the 2T pit, and the width of the 4T pit is about 1.5 times that of the 2T pit. Since the acid diffusion depends on the pit length, the longer the pit is, the more considerably the length is increased from a predetermined pit length. The edge position of each pit also deviates from the predetermined pit length.

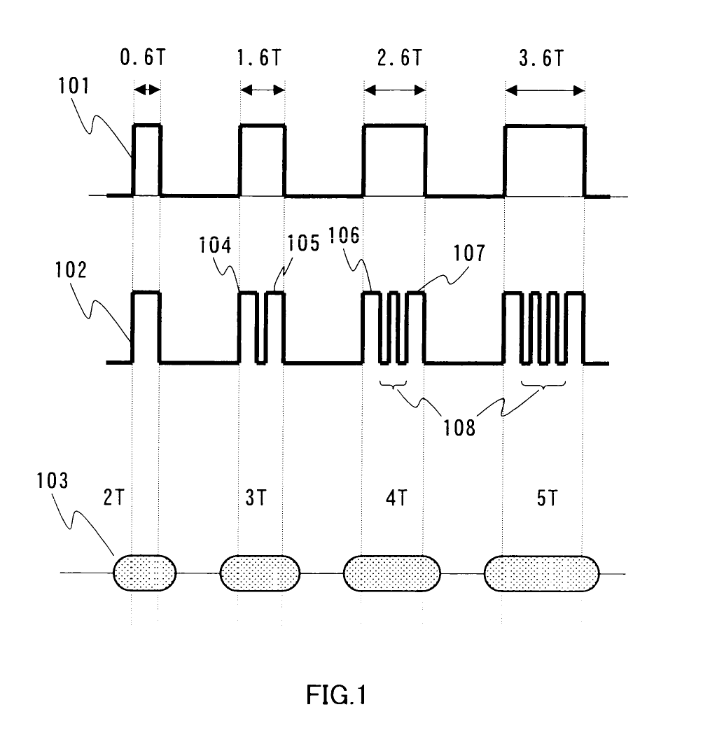

In this embodiment, as shown in FIG. 4, the multipulse converter 413 is used to convert the input information signal into a multipulse signal, and a voltage is applied to the electrode 406. The multipulse converter 413 performs the following conversion process. FIG. 1 shows the relationship between signal patterns before and after conversion and a pit shape to be formed. A signal 101 represents an information signal pattern before conversion, which has been used for conventional recording. A signal 102 represents a multipulse signal pattern obtained by conversion in the multipulse converter 413. Reference numeral 103 denotes a pit shape to be formed.

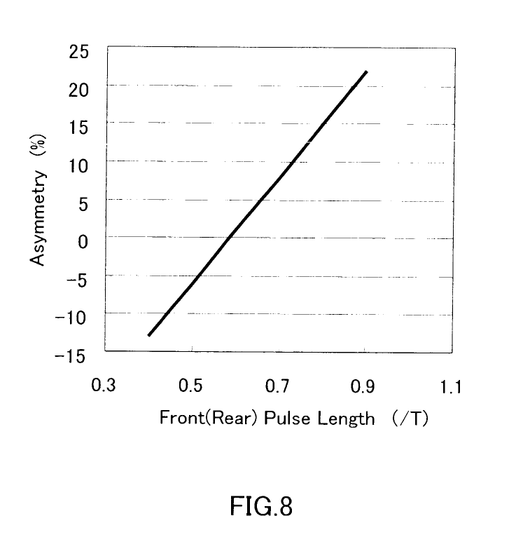

The multipulse signal has been used to form pits by thermal recording, such as a recordable DVD. In the thermal recording, heat is conducted from the leading edge to the trailing edge of a pit. Therefore, the multipulse signal has an asymmetrical pattern with the pulse width being broader on the front side and narrower on the rear side. In the present invention, however, pits are formed by the acid diffusion from an exposed portion. Therefore, unlike the conventional pattern for thermal recording, a symmetrical pattern should be used so that the exposed portions at both ends of a pit exhibit symmetry. To achieve the symmetrical pattern, the 3T pit is divided into two pulses with substantially the same length: a front pulse 104 and a rear pulse 105. Asymmetric behavior is evaluated by setting the length from the leading edge of the front pulse to the trailing edge of the rear pulse to 1.8T and varying the widths of the front pulse and the rear pulse. FIG. 8 plots the asymmetric behavior of the 3T signal against the front and the rear pulse width. When the front pulse has a width of 0.7T, the asymmetry is about 8% and agrees with the asymmetry of the 2T signal. When the front pulse has a width of not less than 0.78T (corresponding to about 130% of an exposure pulse for the 2T pit), the asymmetry is about 15%, and the deviation of the pit length from the 2T pit becomes prominent. The evaluation of reproduction characteristics shows that jitter is increased to 7% or more, and the signal quality cannot be tolerated. When the front pulse has a width of not more than 0.36T (corresponding to about 60% of an exposure pulse for the 2T pit), a space between the front pulse and the rear pulse is too large to record the middle of a pit. The electron microscope observation shows that the pit is split into two parts.

For the 4T pit, a pattern includes a front end pulse 106, a rear end pulse 107, and an intermediate pulse 108 arranged between the front and the rear end pulse. The front end pulse 106 and the rear end pulse 107 have substantially the same length, and the intermediate pulse 108 has a cycle T. As with the 3T pit, the widths of the front end pulse and the rear end pulse are determined by the asymmetric behavior. When the front and the rear end pulse have a width of not less than 0.78T (corresponding to 130% of an exposure pulse for the 2T pit), the asymmetry is 15% or more, and the deviation of the pit edge from the 2T or 3T signal becomes prominent. Thus, the jitter value is increased to 7% or more and not suitable for practical use. When the front and the rear end pulse have a width of not more than 0.24T (corresponding to about 40% of an exposure pulse for the 2T pit), the pit edge is tapered, and the jitter value is increased to 7% or more.

A duty ratio of the intermediate pulse is changed to evaluate the pit shape. The duty ratio indicates the ratio of high to low level of a pulse in the intermediate pulse portion. When the duty ratio is not less than 65%, the width of the 4T pit is about 1.5 times that of the 2T pit. Therefore, this duty ratio is not effective for multipulse recording. When the duty ratio is not more than 45%, the long pit is not exposed sufficiently in the middle and thus is split.

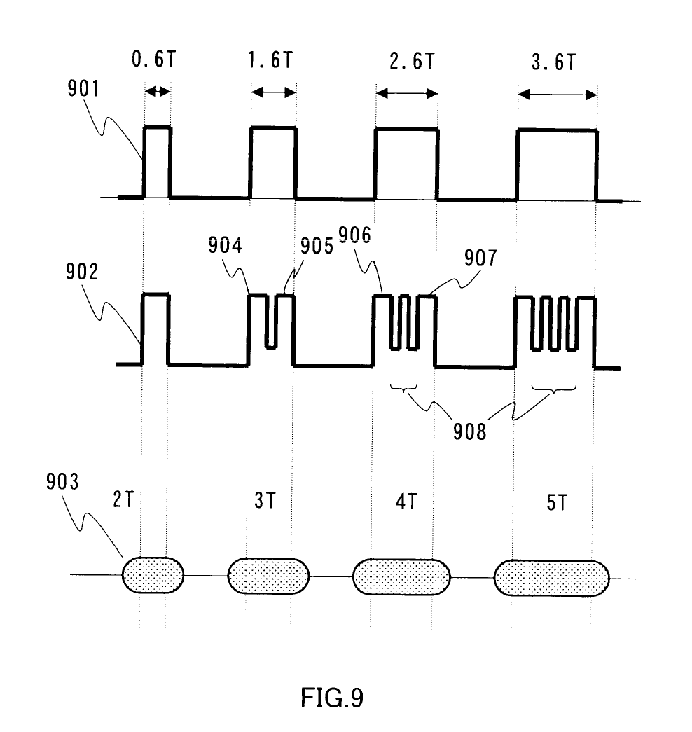

As shown in FIG. 9, a pattern in which the spacing between pulses does not reach the low level also can have the multipulse recording effect. When the spacing is at the low level and the duty ratio is about 50%, a favorable pit shape can be achieved as described above. Even if the spacing is not at the low level, but at a level of not more than about 50% of the high level, as indicated by a signal 902 in FIG. 9, the similar pit shape can be achieved. However, the spacing at a level of not less than 50% leads to a significant difference in width between the long pit and the short pit and is not effective for multipulse recording.

The following method can be used to establish the conditions to obtain good jitter properties.

The pit length can be adjusted by shifting the positions of a front pulse and a rear pulse toward the center by the same amount. In this embodiment, e.g., when both front pulse and rear pulse of the 3T pit are 0.68T, the front pulse is shifted forward by about 0.02T and the rear pulse is shifted backward by about 0.02T. As a result, the asymmetry can be corrected to about 8%. Even if the length of the front pulse differs from that of the rear pulse, the asymmetry can be corrected in the same manner. Moreover, the shift directions of the pulses may be reversed, that is, the front pulse is shifted backward and the rear pulse is shifted forward.

For the pits greater than 3T, the front end pulse and the rear end pulse are shifted forward and backward respectively by the same amount, so that the reproduction jitter can be improved by about 1%. In this case, the shift directions of the pulses may be reversed, that is, the front end pulse is shifted backward and the rear end pulse is shifted forward.

The scanning electron microscope (SEM) observation of a pit shape provided in Embodiment 1 shows that the width of the pits greater than 2T is substantially the same as that of the 2T pit.

The reproduction characteristics of the disk thus produced are evaluated by using a reproduction wavelength of 405 nm, a reproduction linear velocity of 4.9 m/s, and a random pattern measured with a Limit equalizer. The results show good reproduction characteristics: the asymmetry is about 8%, the cycle T is constant, and the jitter is about 5%. Compared with a sample that is produced with a conventional signal and under the same PEB conditions, the jitter can be improved by about 3%.

To study the PEB conditions, a pit shape is evaluated by increasing/decreasing a temperature from the PEB temperature inherent in the resist used. Lower temperatures can reduce the amount of acid diffusion, so that a variation in width and length of short and long pits is reduced, while edge distortion is increased. Particularly when the temperature is not more than the standard specification temperature, the jitter value of each pit is degraded and not suitable for practical use. Higher temperatures can reduce the edge distortion. However, when the temperature is more than a given temperature, the resist material deteriorates to cause pit shape variations. In the case of the chemically amplified resist “UV3,” the multipulse signal pattern is optimized in the range of the standard specification temperature (130° C.) to the deterioration temperature (250° C.), thereby producing a master without any problem.

In this embodiment, a disk that includes only pit trains is produced and evaluated. However, the same process can be used for a disk that includes pits, grooves, etc.

Embodiment 1 employs an electron beam recording apparatus. The present invention also can provide the same effect, e.g., when applied to a recording apparatus that uses a chemically amplified resist or a laser beam recorder (LBR) that uses a far-ultraviolet laser and a chemically amplified resist.

Embodiment 2

Embodiment 2 provides a read-only DVD disk by using a chemically amplified resist and an electron beam recording apparatus. The DVD disk is reproduced by a blue-purple laser with a reproduction wavelength of about 400 nm and has a storage capacity of 20 GB or more. The modulation system is 8-15 modulation in which the shortest pit is a 3T pit whose length is three times longer than a signal clock T. The track pitch is 0.32 μm, and the length of the 3T pit (the shortest pit) is 0.185 μm. In this embodiment, the 3T pit (the shortest pit) is referred to as a first pit, a 4T pit is referred to as a second pit, and further pits are referred to in the order of increasing pit length as a third pit and a fourth pit.

The chemically amplified resist is applied to a silicon wafer master in a thickness of about 100 nm.

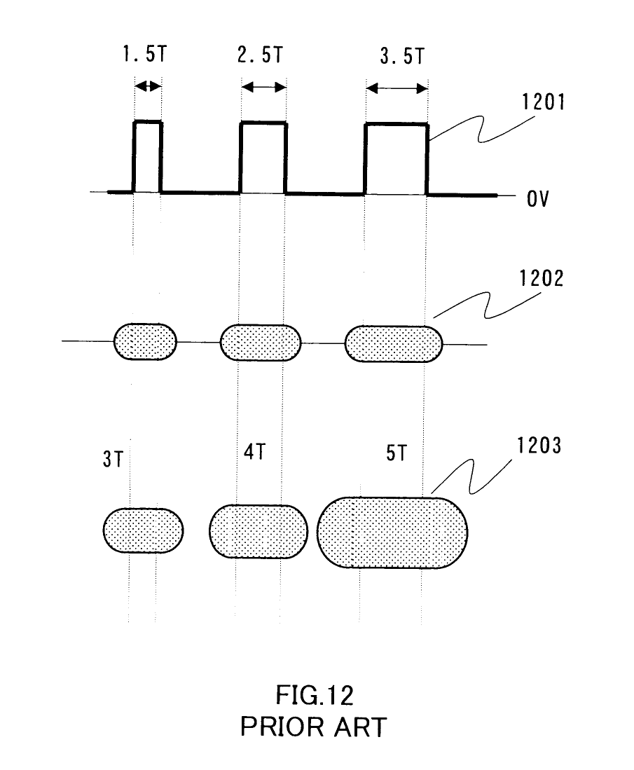

When one signal pit is recorded for one pulse such as a signal 1202 in FIG. 12, the actual exposure time to record the shortest pit (the first pit) 3T should be reduced by half the 3T, i.e., about 1.5T. The reason for this is as follows: when a PEB temperature is about 20° C. higher than the standard specification temperature (130° C.) of the chemically amplified resist used so as to improve the shape of a pit edge, the length of the 3T pit is about two times longer than that of the exposed portion due to acid diffusion. The 4T pit and the 5T pit are formed by the exposure to a 2.5T pulse and a 3.5T pulse, respectively. The width of the 4T pit is about 1.2 times that of the 3T pit, and the width of the 5T pit is about 1.5 times that of the 3T pit. Since the acid diffusion depends on the pit length, the longer the pit is, the more considerably the length is increased from a predetermined pit length. The edge position of each pit also deviates from the predetermined pit length.

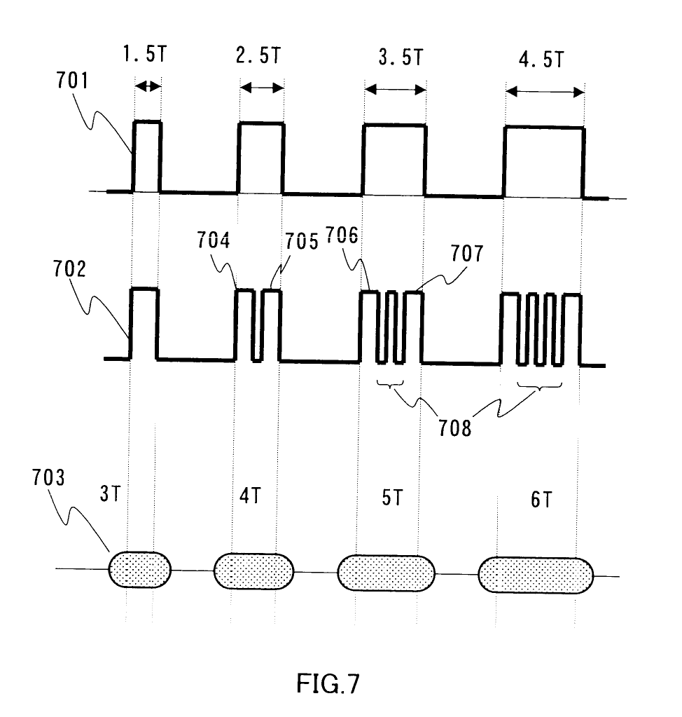

In this embodiment, as shown in FIG. 4, the multipulse converter 413 is used to convert the input information signal into a multipulse signal, and a voltage is applied to the electrode 406. The multipulse converter 413 performs the following conversion process. FIG. 7 shows the relationship between signal patterns before and after conversion and a pit shape to be formed. A signal 701 represents an information signal pattern before conversion, which has been used for conventional recording. A signal 702 represents a multipulse signal pattern obtained by conversion in the multipulse converter 413. Reference numeral 703 denotes a pit shape to be formed. A pit train includes pulses having a length of 3T to 14T. The recording linear velocity is about 4 m/s.

The conditions of each pulse are established in the same manner as Embodiment 1.

The shortest pit 3T is recorded for one pulse that is the same as the initial signal pulse. The pulse length is set so that the 3T pit is exposed for only about 1.5T, since the PEB temperature is about 20° C. higher than the standard specification temperature.

When the 3T pit is exposed to a 1.5T pulse, the asymmetry is about 8%.

For the second shortest pit 4T, a pulse is divided in the middle and converted into two pulses: a front pulse 704 and a rear pulse 705. The front pulse 704 and the rear pulse 705 have substantially the same length and are symmetrical in shape. Thus, the pit shape is not distorted at both ends.

For the 4T pit, asymmetric behavior is evaluated by varying the widths of the front pulse and the rear pulse. When the pulse width is not less than 1.2T (corresponding to about 80% of a 1.5T pulse for recording the 3T pit), the asymmetry is 15% or more, and the pit length deviation becomes prominent. Moreover, the deviation of the asymmetry from the 3T pit degrades the jitter value. When the pulse width is not more than 60% of a 1.5T pulse for recording the 3T pit, the central portion of a pit is not exposed sufficiently due to a decrease in exposure intensity at both ends of the pit. Consequently, the pit is split into two parts.

When the front and the rear pulse have a width of about 1.1T (corresponding to about 70% of a 1.5T pulse), the asymmetry substantially agrees with that of the 3T pit.

For the 5T pit, a pulse is converted into three pulses: a front end pulse 706, a rear end pulse 707, and an intermediate pulse 708 arranged between the front and the rear end pulse. The intermediate pulse 708 has a cycle T. The number of intermediate pulses is increased one by one for the pits greater than 5T. To prevent the distortion of a pit shape, the front end pulse 706 and the rear end pulse 707 have substantially the same length, and the intermediate pulse 708 is located substantially in the middle of these pulses. The widths of the front end pulse and the rear end pulse significantly affect the position of a pit edge to be formed after PEB. When the front and the rear end pulse have a width of 100% of a 1.5T pulse for recording the 3T pit, the asymmetry is about 15% or more, and the pit length is increased considerably and the edge position deviates from the 3T pit. When the front and the rear end pulse have a width of not more than 40%, the pit edge is tapered, and the jitter value is increased to 7% or more.

The width of the intermediate pulse is changed to evaluate the pit shape. When the duty ratio is not more than 45%, the central portion of a pit is not connected, and the pit cannot be formed properly. When the duty ratio is not less than 65%, a long pit is enlarged considerably relative to the 3T pit, and the jitter value is increased to 7% or more.

The following method can be used to establish the conditions to obtain good jitter properties.

The pit length can be adjusted by shifting the positions of a front pulse and a rear pulse toward the center by the same amount. In this embodiment, e.g., when both front pulse and rear pulse of the 4T pit are 1.0T, the front pulse is shifted forward by about 0.1T and the rear pulse is shifted backward by about 0.1T. As a result, the asymmetry can be corrected to about 8%. Even if the length of the front pulse differs from that of the rear pulse, the asymmetry can be corrected in the same manner. Moreover, the shift directions of the pulses may be reversed, that is, the front pulse is shifted backward and the rear pulse is shifted forward.

For the pits greater than 4T, the front end pulse and the rear end pulse are shifted forward and backward respectively by the same amount, so that the reproduction jitter can be improved by about 1%. In this case, the shift directions of the pulses may be reversed, that is, the front end pulse is shifted backward and the rear end pulse is shifted forward.

The scanning electron microscope (SEM) observation of a pit shape provided in Embodiment 2 shows that the width of the pits greater than 3T is substantially the same as that of the 3T pit.

The reproduction characteristics of the disk thus produced are evaluated by using a reproduction wavelength of 405 nm, a reproduction linear velocity of 4.6 m/s, and a random pattern measured with a Limit equalizer. The results show good reproduction characteristics: the asymmetry is about 8%, the cycle T is constant, and the jitter is about 5%. Compared with a sample that is produced with a conventional signal and under the same PEB conditions, the jitter can be improved by about 3%.

To study the PEB conditions, a pit shape is evaluated by increasing/decreasing a temperature from the PEB temperature inherent in the resist used. Lower temperatures can reduce the amount of acid diffusion, so that a variation in width and length of short and long pits is reduced, while edge distortion is increased. This results in the degradation of the jitter value of each pit. Higher temperatures can reduce the edge distortion. However, when the temperature is more than a given temperature, the resist material deteriorates to cause pit shape variations. In the case of the chemically amplified resist “UV3,” the multipulse signal pattern is optimized in the range of the standard specification temperature (130° C.) to the deterioration temperature (250° C.), thereby producing a master without any problem.

Embodiment 2 employs an electron beam recording apparatus. The present invention also can provide the same effect, e.g., when applied to a recording apparatus that uses a chemically amplified resist or a laser beam recorder (LBR) that uses a far-ultraviolet laser and a chemically amplified resist.

Embodiment 3

Embodiment 3 provides a read-only DVD disk by using a chemically amplified resist and an electron beam recording apparatus. The DVD disk is reproduced by a blue-purple laser with a reproduction wavelength of about 400 nm and has a storage capacity of 20 GB or more. The modulation system is 8-15 modulation in which the shortest pit is a 3T pit whose length is three times longer than a signal clock T. The track pitch is 0.32 μm, and the length of the 3T pit (the shortest pit) is 0.185 μm. In this embodiment the 3T pit (the shortest pit) is referred to as a first pit, a 4T pit is referred to as a second pit, and further pits are referred to in the order of increasing pit length as a third pit and a fourth pit. Here, T represents the reproduction clock cycle of a disk.

The chemically amplified resist is applied to a silicon wafer master in a thickness of about 100 nm.

When one signal pit is recorded for one pulse such as a signal 1202 in FIG. 12, the actual exposure time to record the shortest pit (the first pit) 3T should be reduced by half the 3T, i.e., about 1.5T. The reason for this is as follows: when a PEB temperature is about 20° C. higher than the standard specification temperature (130° C.) of the chemically amplified resist used so as to improve the shape of a pit edge, the length of the 3T pit is about two times longer than that of the exposed portion due to acid diffusion. The 4T pit and the 5T pit are formed by the exposure to a 2.5T pulse and a 3.5T pulse, respectively. The width of the 4T pit is about 1.2 times that of the 3T pit, and the width of the 5T pit is about 1.5 times that of the 3T pit. Since the acid diffusion depends on the pit length, the longer the pit is, the more considerably the length is increased from a predetermined pit length. The edge position of each pit also deviates from the predetermined pit length.

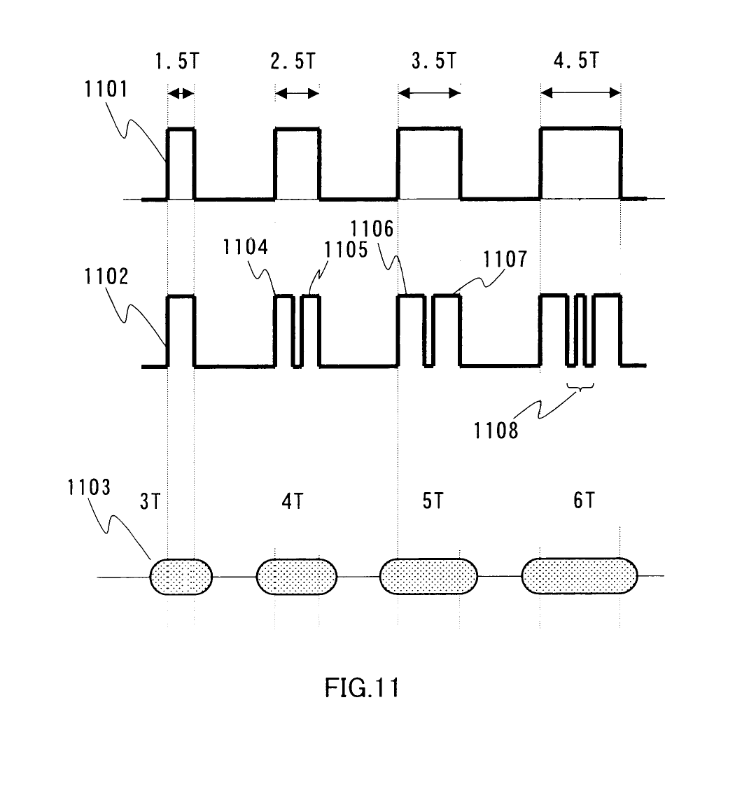

In this embodiment, as shown in FIG. 4, the multipulse converter 413 is used to convert the input information signal into a multipulse signal, and a voltage is applied to the electrode 406. The multipulse converter 413 performs the following conversion process. FIG. 11 shows the relationship between signal patterns before and after conversion and a pit shape to be formed. A signal 1101 represents an information signal pattern before conversion, which has been used for conventional recording. A signal 1102 represents a multipulse signal pattern obtained by conversion in the multipulse converter 413. Reference numeral 1103 denotes a pit shape to be formed. The recording linear velocity is about 4 m/s.

The conditions of each pulse are established in the same manner as Embodiment 1.

The shortest pit 3T is recorded for one pulse that is the same as the initial signal pulse. The pulse length is set so that the 3T pit is exposed for only about 1.5T, since the PEB temperature is about 20° C. higher than the standard specification temperature.

When the 3T pit is exposed to a 1.5T pulse, the asymmetry is about 8%.

For the second shortest pit 4T, a pulse is divided in the middle and converted into two pulses: a front pulse 1104 and a rear pulse 1105. The front pulse 1104 and the rear pulse 1105 have substantially the same length so that the pit shape is not distorted at both ends.

For the 4T pit, asymmetric behavior is evaluated by varying the widths of the front pulse and the rear pulse. When the pulse width is not less than 1.2T (corresponding to about 80% of a 1.5T pulse for recording the 3T pit), the asymmetry is 15% or more, and the pit length deviation becomes prominent. Moreover, the deviation of the asymmetry from the 3T pit degrades the jitter value. When the pulse width is not more than 60% of a 1.5T pulse for recording the 3T pit, the central portion of a pit is not exposed sufficiently due to a decrease in exposure intensity at both ends of the pit. Consequently, the pit is split into two parts.

When the front and the rear pulse have a width of about 1.1T (corresponding to about 70% of a 1.5T pulse), the asymmetry substantially agrees with that of the 3T pit.

For the 5T pit, a pulse is divided in the middle and converted into two pulses: a front end pulse 1106 and a rear end pulse 1107. Asymmetric behavior is evaluated by varying the widths of the front end pulse and the rear end pulse. When the front and the rear end pulse have a width of not less than 1.65T (corresponding to 110% of a 1.5T pulse for recording of the 3T pit), the asymmetry is 15% or more, and the pit length deviation becomes prominent. When the front and the rear end pulse have a width of not more than 1.35T (corresponding to 90% of a 1.5T pulse for recording the 3T pit), the central portion of a pit cannot be recorded, and the pit is split into two parts.

For the 6T pit, a pulse is converted into three pulses: a front end pulse, a rear end pulse, and an intermediate pulse 1108 arranged between the front and the rear end pulse. The intermediate pulse 1108 has a cycle T. The number of intermediate pulses is increased one by one for the pits greater than 6T. To prevent the distortion of a pit shape, the front end pulse 1106 and the rear end pulse 1107 have substantially the same length, and the intermediate pulse 1108 is located substantially in the middle of these pulses.

The widths of the front end pulse and the rear end pulse significantly affect the position of a pit edge to be formed after PEB. When the front and the rear end pulse have a width of 110% of a 1.5T pulse for recording the 3T pit, the asymmetry is about 15% or more, and the pit length is increased considerably and the edge position deviates from the 3T pit. When the front and the rear end pulse have a width of not more than 40%, the pit edge is tapered, and the jitter value is increased to 7% or more.

The width of the intermediate pulse is changed to evaluate the pit shape. When the duty ratio is not more than 45%, the central portion of a pit is not connected, and the pit cannot be formed properly. When the duty ratio is not less than 65%, a long pit is enlarged considerably relative to the 3T pit, thus degrading the jitter value.

The following method can be used to establish the conditions to obtain good jitter properties.

The pit length can be adjusted by shifting the positions of a front pulse and a rear pulse toward the center by the same amount. In this embodiment, e.g., when both front pulse and rear pulse of the 4T pit are 1.0T, the front pulse is shifted forward by about 0.1T and the rear pulse is shifted backward by about 0.1T. As a result, the asymmetry can be corrected to about 8%. Even if the length of the front pulse differs from that of the rear pulse, the asymmetry can be corrected in the same manner. Moreover, the shift directions of the pulses may be reversed, that is, the front pulse is shifted backward and the rear pulse is shifted forward.

For the pits greater than 4T, the front end pulse and the rear end pulse are shifted forward and backward respectively by the same amount, so that the reproduction jitter can be improved by about 1%. In this case, the shift directions of the pulses may be reversed, that is, the front end pulse is shifted backward and the rear end pulse is shifted forward.

The scanning electron microscope (SEM) observation of a pit shape provided in Embodiment 3 shows that the width of the pits greater than 3T is substantially the same as that of the 3T pit.

The reproduction characteristics of the disk thus produced are evaluated by using a reproduction wavelength of 405 nm, a reproduction linear velocity of 4.6 m/s, and a random pattern measured with a Limit equalizer. The results show good reproduction characteristics, and the jitter is about 7%.

Embodiment 4

Embodiment 4 provides a multilayer read-only disk by using a chemically amplified resist and an electron beam recording apparatus. The multilayer disk is reproduced by a blue-purple laser having a reproduction wavelength of about 400 nm and has a storage capacity of 20 GB or more per layer.

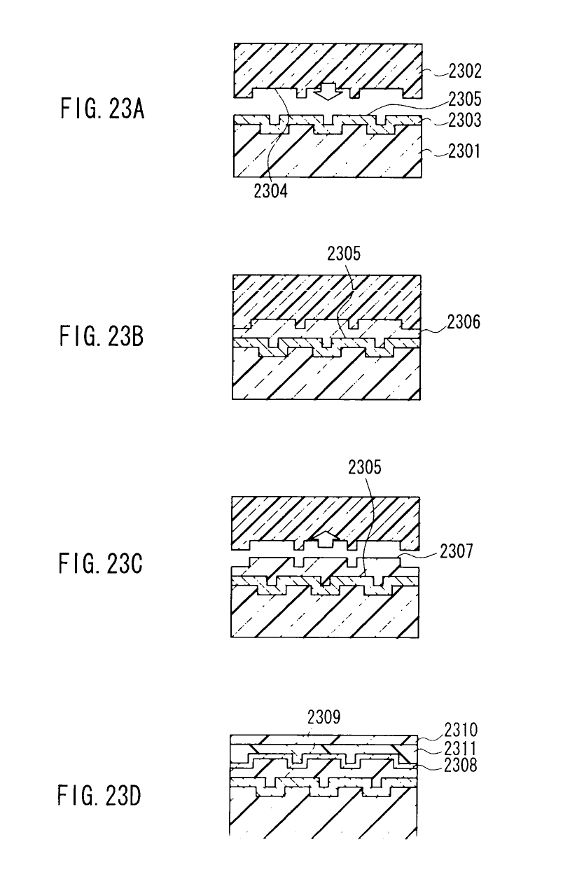

A method for producing an optical disk of Embodiment 4 will be described below. FIGS. 23A to 23D show the method.

First, the chemically amplified resist is applied to a silicon wafer master. The resist-coated silicon wafer is baked and placed in the electron beam recording apparatus, where multipulse signal recording is performed in the same manner as Embodiment 1. The resist master is exposed, post-exposure baked (PEB), and developed to form a concave/convex pattern on the surface.

Next, a metal thin film such as nickel is sputtered on the resist pattern, and then is plated to a thickness of about 0.3 mm by using the metal thin film as an electrode. The resultant metal plate is separated from the resist master, cleaned to remove the resist material that adheres on the surface, and subjected to a drilling process. Thus, a metal stamper for injection molding is produced. Using the metal stamper with an injection molding machine, a resin is molded into a first substrate 2301 having a thickness of about 1.1 mm. The resin thickness can be other than this value.

Another silicon wafer coated with a chemically amplified resist is prepared. The silicon wafer is exposed and recorded in the electron beam recording apparatus to produce a resist master. The recording conditions will be described in detail later.

A metal stamper is produced from the resist master by the above method. Using the metal stamper with an injection molding machine, a resin is molded into a resin substrate 2302 having a thickness of about 1.1 mm. This substrate is referred to as a transfer stamper. A signal pit layer formed on the transfer stamper is referred to as a transfer information surface 2304.

A first reflective film 2303 is formed on the surface of the first substrate that includes pits by sputtering. The first reflective film constitutes a first information surface 2305 (FIG. 23A).

The first information surface 2305 of the first substrate and the transfer information surface 2304 of the transfer stamper are bonded together with a UV curable resin 2306 (FIG. 23B). In this embodiment, the UV curable resin is used directly between the information surfaces. However, the transfer information surface 2304 may be coated with the UV curable resin and bonded to the first substrate with a different adhesive.

Next, the transfer stamper is separated from the bonding surface of the UV curable resin. The UV curable resin can peel off at the interface with the transfer stamper because of its excellent releasability from the resin substrate. Upon removal of the transfer stamper, the shape of the transfer information surface is transferred to the UV curable resin so that transfer pits 2307 are formed on the first information surface 2305 (FIG. 23C).

A second reflective film 2308 that is translucent to reproduction light is formed on the transfer pits by sputtering. The second reflective film constitutes a second information surface 2309 (FIG. 23D).

Subsequently, a sheet substrate 2310 having a thickness of about 0.1 mm is bonded on the second information surface with a UV curable resin by spin coating. Thus, a single-sided two-layer disk is produced that can be read from the sheet substrate side (FIG. 23D). The thickness of the sheet substrate can be other than the above value.

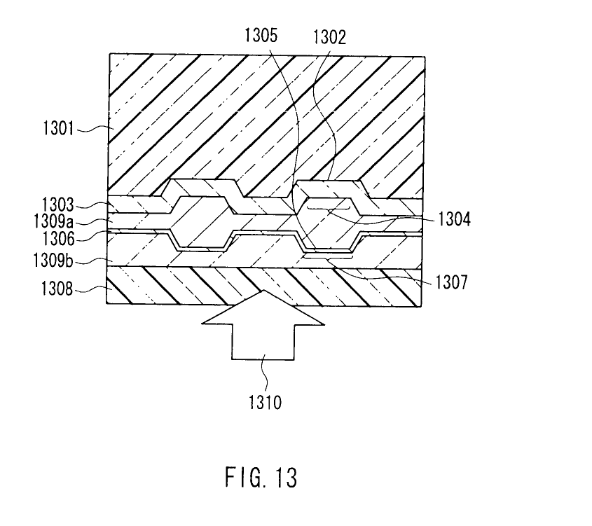

FIG. 13 is a schematic cross-sectional view showing the two-layer disk. Reference numeral 1301 denotes a first substrate, 1302 denotes first signal pits, 1303 denotes a first reflective film, 1304 denotes a first information surface, 1305 denotes transfer pits, 1306 denotes a second reflective film, 1307 denotes a second information surface, 1308 denotes a sheet substrate, 1309a and 1309b denote a UV curable resin, and 1310 denotes a reproduction laser beam.

As shown in FIG. 13, the pit shape of the first information surface that is detected from the reproduction light side can be identified as the pit shape of the first reflective film. Therefore, the pits of the first information surface are made smaller than the first pits formed by injection molding due to the presence of the reflective film.

The second information surface can be identified as the surface of the second reflective film formed on the transfer pits. Therefore, the pits of the second information surface are made larger than the transfer pits. However, the second reflective film is translucent and has a small thickness so that the quantity of light reflected from the first information surface is substantially equal to that reflected from the second information surface. Accordingly, the pit shape of the second reflective film can be substantially the same as the transfer pit shape. In this embodiment, the thickness of the second reflective film is about 20 nm. Thus, the transfer information surface of the transfer stamper should be recorded so that the transfer pit shape is substantially the same as the pit shape of the first reflective film formed on the first pits of the first substrate.

Next, the influence of a change in thickness of the first reflective film will be described. As the recording conditions of the first substrate, the modulation system is 1-7 PP modulation in which the shortest pit is a 2T pit whose length is two times longer than a signal clock, the track pitch is 0.32 μm, and the length of the 2T pit is 0.149 μm. The above recording conditions correspond to a storage capacity of 25 GB. Here, T represents the reproduction clock cycle of a disk. A two-layer disk is produced by using this substrate. To evaluate the two-layer disk, signal reproduction is evaluated with a tester that includes a blue-purple laser source having a wavelength of 405 nm and an optical head provided with an objective lens having a numerical aperture (NA) of 0.85. The reproduction linear velocity is 4.9 m/s.

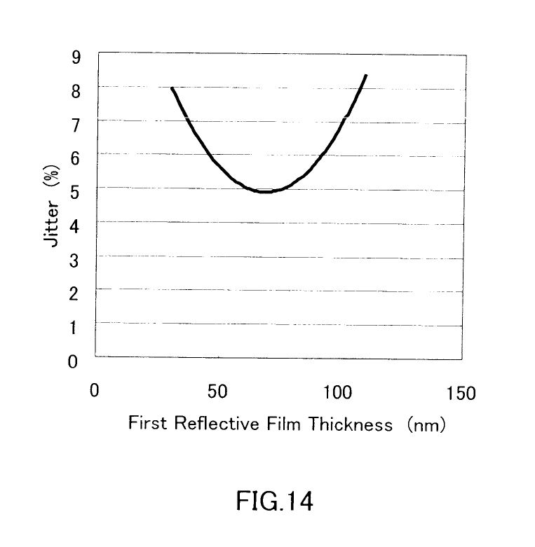

FIG. 14 shows the relationship between the thickness of the first reflective film and the jitter value of a reproduced signal. In view of variables such as a disk tilt, the disk performance allows a jitter of about 7% or less as the bottom jitter. The measurement shows that when the first reflective film has a thickness of less than 40 nm and more than 100 nm, the jitter is increased to 7% or more. Therefore, the preferred thickness of the first reflective film is 40 nm to 100 nm.

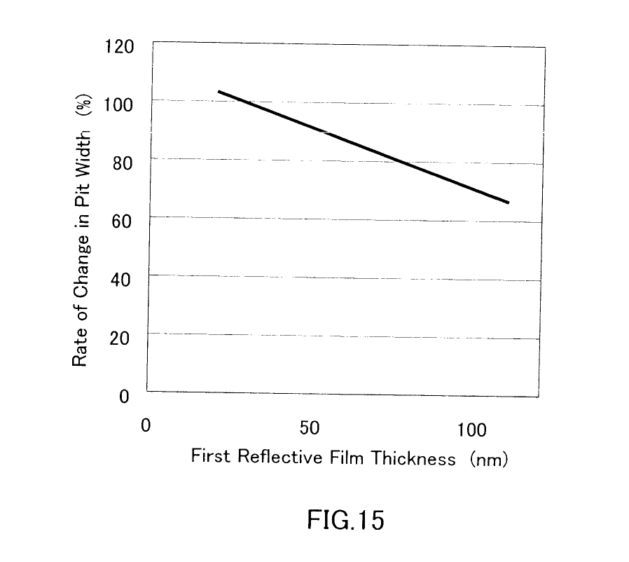

The following is an explanation of a change in pit shape of the first substrate caused by the formation of the first reflective film. FIG. 15 shows the relationship between the thickness of the first reflective film and the rate of change at which the pit width of the first substrate after forming the first reflective film changes with respect to that before forming the first reflective film. As shown in FIG. 15, when the first reflective film has a thickness of 40 nm, the pit width is about 95%. When the first reflective film has a thickness of 100 nm, the pit width is about 70%.

Next, the recording conditions of the transfer information surface will be described. The pit shape of the transfer information surface should be substantially the same as that of the first information surface.

When the production process of an optical disk includes: using a transfer stamper that has a transfer information surface 2304 in which a signal pattern including concave pits is formed; transferring the signal pattern to a UV curable resin; and forming transfer pits 2307 (1305) in the information surface, the shape of the transfer pits may be changed significantly from that of the pits (with different lengths and widths) of the transfer information surface depending on the state of transfer to the resin. Therefore, the pit shape should be determined by taking into consideration the transfer characteristics.

The transfer pit shape is evaluated by varying the viscosity of the UV resin. When the viscosity is more than 500 mPa·s, pits with a length of 2T are not transferred sufficiently, and almost no 2T pit is formed on the information surface. When the viscosity is less than 40 mPa·s, though the transfer characteristics are improved, the pit shape is distorted during removal of the transfer stamper, and the necessary pit shape cannot be achieved. In this embodiment, a UV curable resin having a viscosity of about 200 mPa·s is used to produce the two-layer disk.

The recording conditions of the transfer stamper will be described below.

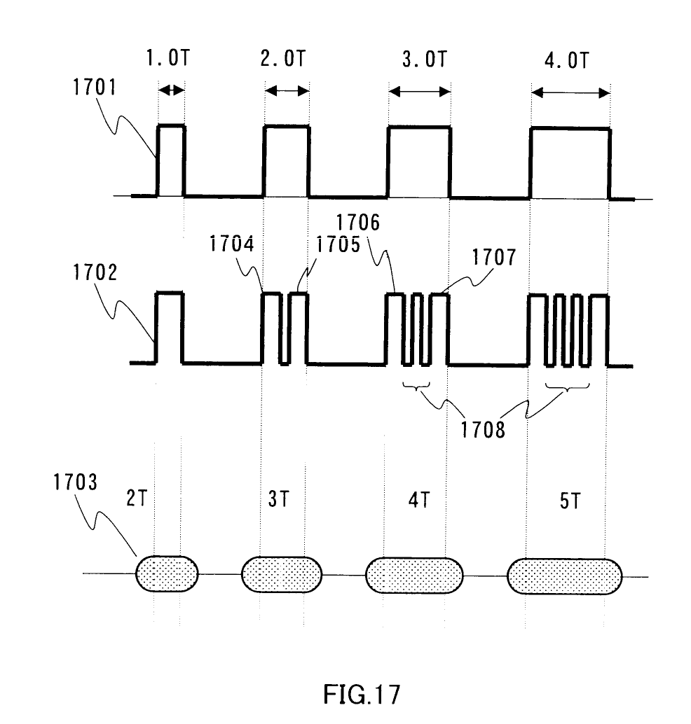

As shown in FIG. 4, the multipulse converter 413 is used to convert the input information signal into a multipulse signal, and a voltage is applied to the electrode 406. The multipulse converter 413 performs the following conversion process. FIG. 17 shows the relationship between signal patterns before and after conversion and a pit shape to be formed. A signal 1701 represents an information signal pattern before conversion, which has been used for conventional recording. A signal 1702 represents a multipulse signal pattern obtained by conversion in the multipulse converter 413. Reference numeral 1703 denotes a pit shape to be formed.

The multipulse signal has been used to form pits by thermal recording, such as a recordable DVD. In the thermal recording, heat is conducted from the leading edge to the trailing edge of a pit. Therefore, the multipulse signal has an asymmetrical pattern with the pulse width being broader on the front side and narrower on the rear side. In the present invention, however, pits are formed by the acid diffusion from an exposed portion. Therefore, unlike the conventional pattern for thermal recording, a symmetrical pattern should be used so that the exposed portions at both ends of a pit exhibit symmetry.

The recording conditions of a 2T pit (the shortest pit) are controlled. When the 2T pit is formed under the same recording conditions as the first substrate and transferred to a UV curable resin, the transfer pit is reduced in size according to the transfer ratio. By using a recording power that is about 10% higher than the recording power for the first substrate, the shape of the 2T pit after transfer is substantially the same as that of the 2T pit of the first substrate.

The evaluation of a reproduced signal under the above conditions shows that the asymmetry of the 2T signal is about 8%.

The recording conditions of the pits greater than 2T are controlled. The width of the pits greater than 2T is adjusted to be substantially the same as that of the 2T pit, so that the transfer pits have the same width. The shift of each pit in the length direction is made by adjusting the multipulse signal.

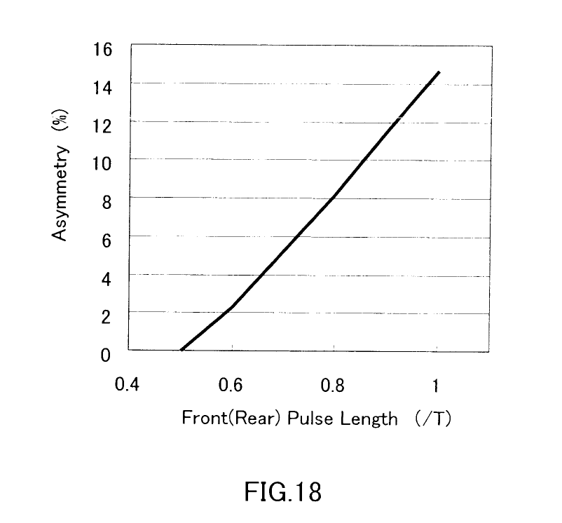

The 3T pit has a symmetrical pattern that includes two pulses with substantially the same length: a front pulse 1704 and a rear pulse 1705. Asymmetric behavior is evaluated by setting the length from the leading edge of the front pulse to the trailing edge of the rear pulse to 2.0T and varying the widths of the front pulse and the rear pulse. FIG. 18 plots the asymmetric behavior of the 3T signal against the front and the rear pulse width. When the front pulse has a width of 0.8T, the asymmetry is about 8% and agrees with the asymmetry of the 2T signal. When the front pulse has a width of not less than 1.0T (corresponding to about 100% of an exposure pulse for the 2T pit), the asymmetry is about 15%, and the deviation of the pit length from the 2T pit becomes prominent. Thus, jitter is increased to 7% or more and not suitable for practical use. When the front pulse has a width of not more than 0.5T (corresponding to about 50% of an exposure pulse for the 2T pit), a space between the front pulse and the rear pulse is too large to record the middle of a pit. Consequently, the pit is split into two parts.

For the 4T pit, a pattern includes a front end pulse 1706, a rear end pulse 1707, and an intermediate pulse 1708 arranged between the front and the rear end pulse. The front end pulse 1706 and the rear end pulse 1707 have substantially the same length, and the intermediate pulse 1708 has a cycle T. As with the 3T pit, the widths of the front end pulse and the rear end pulse are determined by the asymmetric behavior during reproduction of the transfer pits. When the front and the rear end pulse have a width of not less than 1.0T (corresponding to about 110% of an exposure pulse for the 2T pit), the asymmetry is 15% or more, and the deviation of the pit edge from the 2T or 3T signal becomes prominent. Thus, the jitter value is increased to 7% or more and not suitable for practical use. When the front and the rear end pulse have a width of not more than 0.35T (corresponding to about 40% of an exposure pulse for the 2T pit), the pit edge is tapered, and the jitter value is increased to 7% or more.

A duty ratio of the intermediate pulse is changed to evaluate the pit shape. When the duty ratio is not less than 65%, the width of the 4T pit is about 1.4 times that of the 2T pit after transfer. Therefore, this duty ratio is not effective for multipulse recording. When the duty ratio is not more than 45%, the long pit is not exposed sufficiently in the middle and thus is split.

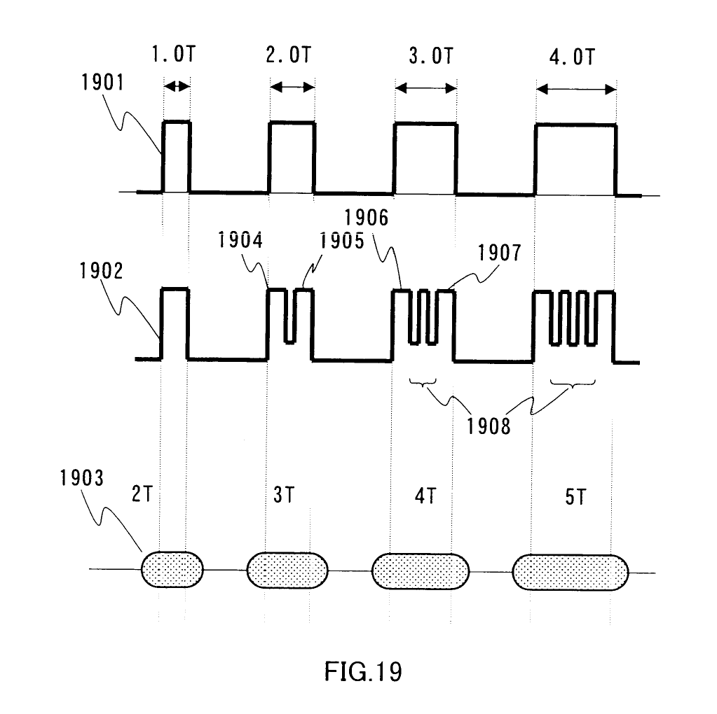

As shown in FIG. 19, a pattern in which the spacing between pulses does not reach the low level also can have the multipulse recording effect. When the spacing is at the low level and the duty ratio is about 50%, a favorable pit shape can be achieved as described above. Even if the spacing is not at the low level, but at a level of not more than about 50% of the high level, as indicated by a signal 1902 in FIG. 19, the similar pit shape can be achieved. However, the spacing at a level of not less than 50% leads to a significant difference in width between the long pit and the short pit and is not effective for multipulse recording.

The following method can be used to establish the conditions to obtain good jitter properties.

The pit length can be adjusted by shifting the positions of a front pulse and a rear pulse toward the center by the same amount. In this embodiment, e.g., when both front pulse and rear pulse of the 3T pit are 0.85T, the front pulse is shifted backward by about 0.02T and the rear pulse is shifted forward by about 0.02T. As a result, the asymmetry can be corrected to about 8%. Even if the length of the front pulse differs from that of the rear pulse, the asymmetry can be corrected in the same manner. Moreover, the shift directions of the pulses may be reversed, that is, the front pulse is shifted forward and the rear pulse is shifted backward.

For the pits greater than 3T, the front end pulse and the rear end pulse are shifted forward and backward respectively by the same amount, so that the reproduction jitter can be improved by about 1%. In this case, the shift directions of the pulses may be reversed, that is, the front end pulse is shifted backward and the rear end pulse is shifted forward.

It is most difficult to transfer the shortest pit. This embodiment uses the shortest pit having a length of 0.149 μm. When the length is less than 0.1 μm, the transfer characteristics of the UV curable resin becomes extremely poor, and the pit hardly can be transferred. When the length is not less than 0.3 μm, a difference in transfer characteristics between long and short pits becomes smaller, and the effect of the present invention is reduced.

The scanning electron microscope (SEM) observation of a transfer pit shape provided in Embodiment 4 shows that the width of the pits greater than 2T is substantially the same as that of the 2T pit. Moreover, the transfer pit shape is substantially the same as the pit shape of the first information surface.

The reproduction characteristics of the disk thus produced are evaluated by using a reproduction wavelength of 405 nm, a reproduction linear velocity of 4.9 m/s, and a random pattern measured with a Limit equalizer. The results show that each layer has good reproduction characteristics, and the jitter is about 5%.

To study the PEB conditions, a pit shape of the transfer stamper is evaluated by increasing/decreasing a temperature from the PEB temperature inherent in the resist used. Lower temperatures can reduce the amount of acid diffusion, so that a variation in width and length of short and long pits is reduced, while edge distortion is increased. The similar edge distortion is observed also after transfer. Particularly when the temperature is not more than the standard specification temperature, the jitter value is degraded and not suitable for practical use. Higher temperatures can reduce the edge distortion. However, when the temperature is more than a given temperature, the resist material deteriorates to cause pit shape variations. In the case of the chemically amplified resist “UV3,” the resist is used in the range of the standard specification temperature (130° C.) to the deterioration temperature (250° C.), thereby producing a master without any problem.

In this embodiment, a disk that includes only pit trains is produced and evaluated. However, the same process can be used for a disk that includes pits, grooves, etc.

This embodiment describes experiments on the two-layer disk. However, a multilayer disk also can provide the same effect, in which layers having transfer pits are stacked in order by using a transfer stamper with a UV curable resin, and the pit shape of each layer can be optimized in the same manner.

The pit size of each layer differs depending on whether a reflective film is formed on the side of the resin pits that faces to reproduction light or the opposite side of the resin pits that faces away from the reproduction light. In such a case, the present invention is effective in adjusting the pit shape so that the pit size of each layer is substantially the same.

Embodiment 4 employs an electron beam recording apparatus. The present invention also can provide the same effect, e.g., when applied to a recording apparatus that uses a chemically amplified resist or a laser beam recorder (LBR) that uses a far-ultraviolet laser and a chemically amplified resist.

Embodiment 5

In this embodiment, the two-layer disk structure in Embodiment 4 is used to record a 3T random pit pattern. The pit shape of a transfer stamper is optimized in the same manner as Embodiment 4.

The following is an explanation of a method for forming a transfer information surface and the recording conditions of the transfer stamper. The transfer stamper has a recording density of 25 GB, which is the same as that of a first substrate. The track pitch is 0.32 μm, and the length of a 3T pit (the shortest pit) is 0.185 μm.

The actual exposure time to record the shortest pit (a first pit) 3T should be reduced by half the 3T, i.e., about 1.5T. The reason for this is as follows: when a PEB temperature is about 20° C. higher than the standard specification temperature (130° C.) of the chemically amplified resist used so as to improve the shape of a pit edge, the length of the 3T pit is about two times longer than that of the exposed portion due to acid diffusion. The 4T pit and the 5T pit are formed by the exposure to a 2.5T pulse and a 3.5T pulse, respectively. When these pits are recorded without using a multipulse signal, the width of the 4T pit is about 1.2 times that of the 3T pit, and the width of the 5T pit is about 1.5 times that of the 3T pit on the molded substrate. A transfer process is performed by using this transfer stamper with a UV curable resin having a viscosity of about 200 mPa·s to evaluate the shape of transfer pits. The results show that the width of the 3T pit (the shortest pit) is about 60% of the width of the other long pits, and the shape of the 3T pit also differs significantly from that of the long pits.

To solve the problem, the pit shape is optimized with a multipulse signal.

The recording conditions of the transfer stamper will be described below.

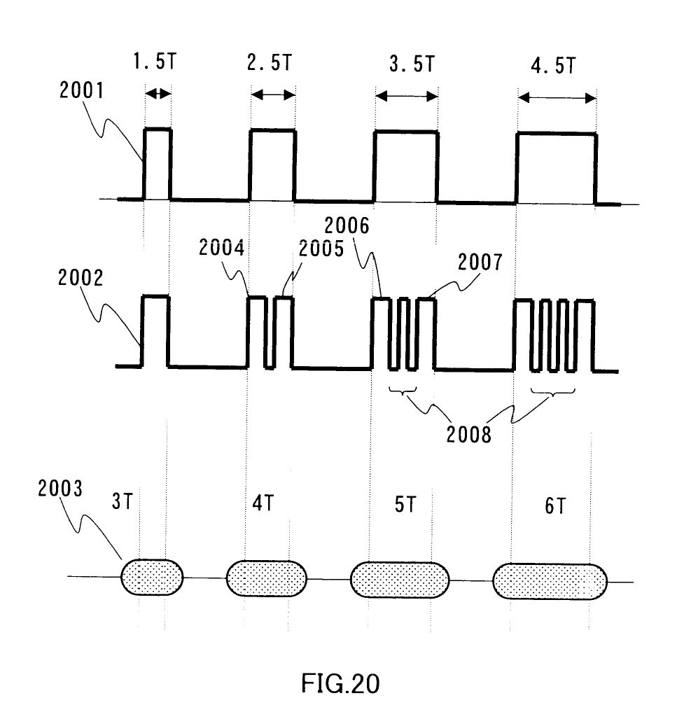

As shown in FIG. 4, the multipulse converter 413 is used to convert the input information signal into a multipulse signal, and a voltage is applied to the electrode 406. The multipulse converter 413 performs the following conversion process. FIG. 20 shows the relationship between signal patterns before and after conversion and a pit shape to be formed. A signal 2001 represents an information signal pattern before conversion, which has been used for conventional recording. A signal 2002 represents a multipulse signal pattern obtained by conversion in the multipulse converter 413. Reference numeral 2003 denotes a pit shape to be formed.

The recording conditions of the 3T pit (the shortest pit) are controlled. When the 3T pit is formed under the same recording conditions as the first substrate and transferred to a UV curable resin, the transfer pit is reduced in size according to the transfer ratio. By using a recording power that is about 10% higher than the recording power for the first substrate, the shape of the 3T pit after transfer is substantially the same as that of the 3T pit of the first substrate.

The recording conditions of the pits greater than 3T are controlled. The width of the pits greater than 3T is adjusted to be substantially the same as that of the 3T pit, so that the transfer pits have the same width. The shift of each pit in the length direction is made by adjusting the multipulse signal.

For the second shortest pit 4T, a pulse is divided in the middle and converted into two pulses: a front pulse 2004 and a rear pulse 2005. The front pulse 2004 and the rear pulse 2005 have substantially the same length and are symmetrical in shape. Thus, the pit shape is not distorted at both ends.

For the 4T pit, asymmetric behavior is evaluated by varying the widths of the front pulse and the rear pulse. When the pulse width is not less than 1.2T (corresponding to about 80% of a 1.5T pulse for recording the 3T pit), the asymmetry is 15% or more, and the pit length deviation becomes prominent. Moreover, the deviation of the asymmetry from the 3T pit degrades the jitter value. When the pulse width is not more than 50% of a 1.5T pulse for recording the 3T pit, the central portion of a pit is not exposed sufficiently due to a decrease in exposure intensity at both ends of the pit. Consequently, the pit is split into two parts.

When the front and the rear pulse have a width of about 1.1T (corresponding to about 70% of a 1.5T pulse), the asymmetry substantially agrees with that of the 3T pit.

For the 5T pit, a pulse is converted into three pulses: a front end pulse 2006, a rear end pulse 2007, and an intermediate pulse 2008 arranged between the front and the rear end pulse. The intermediate pulse 2008 has a cycle T. The number of intermediate pulses is increased one by one for the pits greater than 5T. To prevent the distortion of a pit shape, the front end pulse 2006 and the rear end pulse 2007 have substantially the same length, and the intermediate pulse 2008 is located substantially in the middle of these pulses. The widths of the front end pulse and the rear end pulse significantly affect the position of a pit edge to be formed after PEB. When the front and the rear end pulse have a width of 100% of a 1.5T pulse for recording the 3T pit, the asymmetry is about 15% or more, and the pit length is increased considerably and the edge position deviates from the 3T pit. When the front and the rear end pulse have a width of not more than 40%, the pit edge is tapered, and the jitter value is increased to 7% or more.

The width of the intermediate pulse is changed to evaluate the pit shape. When the duty ratio is not more than 45%, the central portion of a pit is not connected, and the pit cannot be formed properly. When the duty ratio is not less than 65%, a long pit is enlarged considerably relative to the 3T pit, thus degrading the jitter value.

The following method can be used to establish the conditions to obtain good jitter properties.

The pit length can be adjusted by shifting the positions of a front pulse and a rear pulse toward the center by the same amount. In this embodiment, e.g., when both front pulse and rear pulse of the 4T pit are 1.0T, the front pulse is shifted forward by about 0.1T and the rear pulse is shifted backward by about 0.1T. As a result, the asymmetry can be corrected to about 8%. Even if the length of the front pulse differs from that of the rear pulse, the asymmetry can be corrected in the same manner. Moreover, the shift directions of the pulses may be reversed, that is, the front pulse is shifted backward and the rear pulse is shifted forward.

For the pits greater than 4T, the front end pulse and the rear end pulse are shifted forward and backward respectively by the same amount, so that the reproduction jitter can be improved by about 1%. In this case, the shift directions of the pulses may be reversed, that is, the front end pulse is shifted backward and the rear end pulse is shifted forward.

The scanning electron microscope (SEM) observation of a transfer pit shape provided in Embodiment 5 shows that the width of the pits greater than 3T is substantially the same as that of the 3T pit. Moreover, the transfer pit shape is substantially the same as the pit shape of the first information surface.

The reproduction characteristics of the disk thus produced are evaluated by using a reproduction wavelength of 405 nm, a reproduction linear velocity of 5.1 m/s, and a random pattern measured with a Limit equalizer. The results show that each layer has good reproduction characteristics, and the jitter is about 5%.

To study the PEB conditions, a pit shape of the transfer stamper is evaluated by increasing/decreasing a temperature from the PEB temperature inherent in the resist used. Lower temperatures can reduce the amount of acid diffusion, so that a variation in width and length of short and long pits is reduced, while edge distortion is increased. The similar edge distortion is observed also after transfer. Particularly when the temperature is not more than the standard specification temperature, the jitter value is degraded and not suitable for practical use. Higher temperatures can reduce the edge distortion. However, when the temperature is more than a given temperature, the resist material deteriorates to cause pit shape variations. In the case of the chemically amplified resist “UV3,” the resist is used in the range of the standard specification temperature (130° C.) to the deterioration temperature (250° C.), thereby producing a master without any problem.

In this embodiment, a disk that includes only pit trains is produced and evaluated. However, the same process can be used for a disk that includes pits, grooves, etc.

This embodiment describes experiments on the two-layer disk. However, a multilayer disk also can provide the same effect, in which layers having transfer pits are stacked in order by using a transfer stamper with a UV curable resin, and the pit shape of each layer can be optimized in the same manner.

The pit size of each layer differs depending on whether a reflective film is formed on the side of the resin pits that faces to reproduction light or the opposite side of the resin pits that faces away from the reproduction light. In such a case, the present invention is effective in adjusting the pit shape so that the pit size of each layer is substantially the same.

Embodiment 5 employs an electron beam recording apparatus. The present invention also can provide the same effect, e.g., when applied to a recording apparatus that uses a chemically amplified resist or a laser beam recorder (LBR) that uses a far-ultraviolet laser and a chemically amplified resist.

Embodiment 6

In this embodiment, the two-layer disk structure in Embodiment 4 is used to record a 3T random pit pattern. The pit shape of a transfer stamper is optimized in the same manner as Embodiment 4.

The following is an explanation of a method for forming a transfer information surface and the recording conditions of the transfer stamper. The transfer stamper has a recording density of 25 GB, which is the same as that of a first substrate. The track pitch is 0.32 μm, and the length of a 3T pit (the shortest pit) is 0.185 μm.

The actual exposure time to record the shortest pit (a first pit) 3T should be reduced by half the 3T, i.e., about 1.5T. The reason for this is as follows: when a PEB temperature is about 20° C. higher than the standard specification temperature (130° C.) of the chemically amplified resist used so as to improve the shape of a pit edge, the length of the 3T pit is about two times longer than that of the exposed portion due to acid diffusion. The 4T pit and the 5T pit are formed by the exposure to a 2.5T pulse and a 3.5T pulse, respectively. When these pits are recorded without using a multipulse signal, the width of the 4T pit is about 1.2 times that of the 3T pit, and the width of the 5T pit is about 1.5 times that of the 3T pit on the molded substrate. A transfer process is performed by using this transfer stamper with a UV curable resin having a viscosity of about 200 mPa·s to evaluate the shape of transfer pits. The results show that the width of the 3T pit (the shortest pit) is about 60% of the width of the other long pits, and the shape of the 3T pit also differs significantly from that of the long pits.

To solve the problem, the pit shape is optimized with a multipulse signal.

The recording conditions of the transfer stamper will be described below.

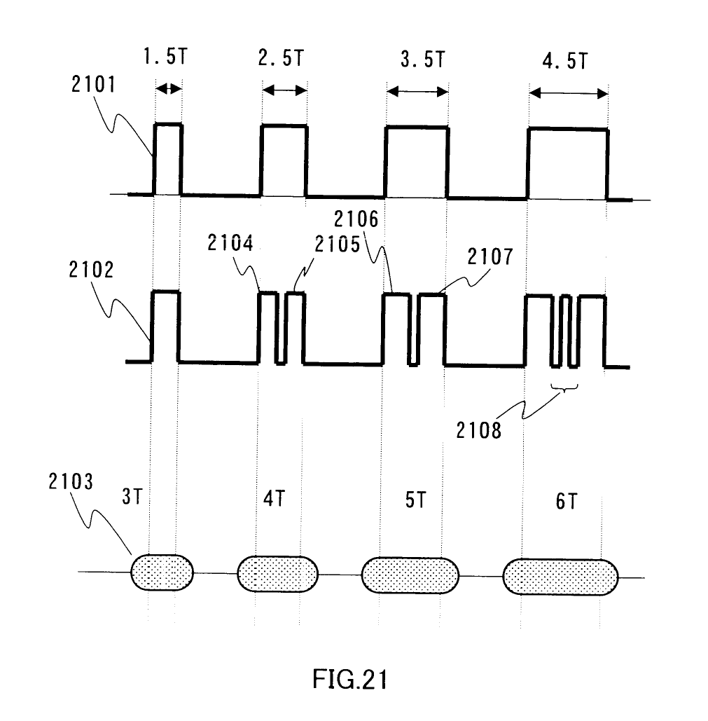

As shown in FIG. 4, the multipulse converter 413 is used to convert the input information signal into a multipulse signal, and a voltage is applied to the electrode 406. The multipulse converter 413 performs the following conversion process. FIG. 21 shows the relationship between signal patterns before and after conversion and a pit shape to be formed. A signal 2101 represents an information signal pattern before conversion, which has been used for conventional recording. A signal 2102 represents a multipulse signal pattern obtained by conversion in the multipulse converter 413. Reference numeral 2103 denotes a pit shape to be formed.

The recording conditions of the 3T pit (the shortest pit) are controlled. When the 3T pit is formed under the same recording conditions as the first substrate and transferred to a UV curable resin, the transfer pit is reduced in size according to the transfer ratio. By using a recording power that is about 10% higher than the recording power for the first substrate, the shape of the 3T pit after transfer is substantially the same as that of the 3T pit of the first substrate.

The recording conditions of the pits greater than 3T are controlled. The width of the pits greater than 3T is adjusted to be substantially the same as that of the 3T pit, so that the transfer pits have the same width. The shift of each pit in the length direction is made by adjusting the multipulse signal.

For the second shortest pit 4T, a pulse is divided in the middle and converted into two pulses: a front pulse 2104 and a rear pulse 2105. The front pulse 2104 and the rear pulse 2105 have substantially the same length and are symmetrical in shape. Thus, the pit shape is not distorted at both ends.

For the 4T pit, asymmetric behavior is evaluated by varying the widths of the front pulse and the rear pulse. When the pulse width is not less than 1.2T (corresponding to about 80% of a 1.5T pulse for recording the 3T pit), the asymmetry is 15% or more, and the pit length deviation becomes prominent. Moreover, the deviation of the asymmetry from the 3T pit degrades the jitter value. When the pulse width is not more than 50% of a 1.5T pulse for recording the 3T pit, the central portion of a pit is not exposed sufficiently due to a decrease in exposure intensity at both ends of the pit. Consequently, the pit is split into two parts.

When the front and the rear pulse have a width of about 1.1T (corresponding to about 70% of a 1.5T pulse), the asymmetry substantially agrees with that of the 3T pit.

For the 5T pits, a pulse is divided in the middle and converted into two pulses: a front end pulse 2106 and a rear end pulse 2107. Asymmetric behavior is evaluated by varying the widths of the front end pulse and the rear end pulse. When the front and the rear end pulse have a width of not less than 1.65T (corresponding to 110% of a 1.5T pulse for recording the 3T pit), the asymmetry is 15% or more, and the pit length deviation becomes prominent. When the front and the rear end pulse have a width of not more than 1.05T (corresponding to 70% of a 1.5T pulse for recording the 3T pit), the central portion of a pit cannot be recorded, and the pit is split into two parts.

For the 6T pit, a pulse is converted into three pulses: a front end pulse, a rear end pulse, and an intermediate pulse 2108 arranged between the front and the rear end pulse. The intermediate pulse 2108 has a cycle T. The number of intermediate pulses is increased one by one for the pits greater than 6T. To prevent the distortion of a pit shape, the front end pulse 2106 and the rear end pulse 2107 have substantially the same length, and the intermediate pulse 2108 is located substantially in the middle of these pulses.

The widths of the front end pulse and the rear end pulse significantly affect the position of a pit edge to be formed after PEB. When the front and the rear end pulse have a width of 110% of a 1.5T pulse for recording the 3T pit, the asymmetry is about 15% or more, and the pit length is increased considerably and the edge position deviates from the 3T pit. When the front and the rear end pulse have a width of not more than 70%, the pit edge is tapered, and the jitter value is increased to 7% or more.

The width of the intermediate pulse is changed to evaluate the pit shape. When the duty ratio is not more than 45%, the central portion of a pit is not connected, and the pit cannot be formed properly. When the duty ratio is not less than 65%, a long pit is enlarged considerably relative to the 3T pit, thus degrading the jitter value.

The following method can be used to establish the conditions to obtain good jitter properties.

When the front pulse of the 4T pit is 1.2T, the pit length is longer than a predetermined pit length, and the asymmetry is about 15%. However, the pit length can be adjusted by shifting the positions of a front pulse and a rear pulse toward the center by the same amount. In this embodiment, e.g., when both front pulse and rear pulse of the 4T pit are 1.0T, the front pulse is shifted backward by about 0.1T and the rear pulse is shifted forward by about 0.1T. As a result, the asymmetry can be reduced to about 8%. Moreover, the asymmetry substantially can agree with that of the other pits with different lengths (T), the front and the rear pulse can be exposed and recorded reliably, and a favorable transfer pit shape can be achieved. For the pits greater than 3T, the front end pulse and the rear end pulse are shifted backward and forward respectively by the same amount, so that the reproduction jitter can be improved by about 1%.

The scanning electron microscope (SEM) observation of a transfer pit shape provided in Embodiment 6 shows that the width of the pits greater than 3T is substantially the same as that of the 3T pit. Moreover, the transfer pit shape is substantially the same as the pit shape of the first information surface.

The reproduction characteristics of the disk thus produced are evaluated by using a reproduction wavelength of 405 nm, a reproduction linear velocity of 5.1 m/s, and a random pattern measured with a Limit equalizer. The results show that each layer has good reproduction characteristics, and the jitter is about 5%.

To study the PEB conditions, a pit shape of the transfer stamper is evaluated by increasing/decreasing a temperature from the PEB temperature inherent in the resist used. Lower temperatures can reduce the amount of acid diffusion, so that a variation in width and length of short and long pits is reduced, while edge distortion is increased. The similar edge distortion is observed also after transfer. Particularly when the temperature is not more than the standard specification temperature, the jitter value is degraded and not suitable for practical use. Higher temperatures can reduce the edge distortion. However, when the temperature is more than a given temperature, the resist material deteriorates to cause pit shape variations. In the case of the chemically amplified resist “UV3,” the resist is used in the range of the standard specification temperature (130° C.) to the deterioration temperature (250° C.), thereby producing a master without any problem.

In this embodiment, a disk that includes only pit trains is produced and evaluated. However, the same process can be used for a disk that includes pits, grooves, etc.

This embodiment describes experiments on the two-layer disk. However, a multilayer disk also can provide the same effect, in which layers having transfer pits are stacked in order by using a transfer stamper with a UV curable resin, and the pit shape of each layer can be optimized in the same manner.

Embodiment 6 employs an electron beam recording apparatus. The present invention also can provide the same effect, e.g., when applied to a recording apparatus that uses a chemically amplified resist or a laser beam recorder (LBR) that uses a far-ultraviolet laser and a chemically amplified resist.

Embodiment 7

Embodiment 7 provides a multilayer read-only disk by using a chemically amplified resist and an electron beam recording apparatus. The multilayer disk is reproduced by a blue-purple laser having a reproduction wavelength of about 400 nm and has a storage capacity of 20 GB or more per layer.

A method for producing an optical disk of Embodiment 7 will be described below.

First, the chemically amplified resist is applied to a silicon wafer master. The resist-coated silicon wafer is baked and placed in the electron beam recording apparatus, where multipulse signal recording is performed in the same manner as Embodiment 1. The resist master is exposed, post-exposure baked (PEB), and developed to form a concave/convex pattern on the surface.

Next, a metal thin film such as nickel is sputtered on the resist pattern, and then is plated to a thickness of about 0.3 mm by using the metal thin film as an electrode. The resultant metal plate is separated from the resist master, cleaned to remove the resist material that adheres on the surface, and subjected to a drilling process. Thus, a metal stamper for injection molding is produced. Using the metal stamper with an injection molding machine, a resin is molded into a first substrate having a thickness of about 1.1 mm. The resin thickness can be other than this value.

Another silicon wafer coated with a chemically amplified resist is prepared. The silicon wafer is exposed and recorded in the electron beam recording apparatus to produce a resist master. The recording conditions will be described in detail later.

A metal stamper is produced from the resist master by the above method. Using the metal stamper with an injection molding machine, a resin is molded into a resin substrate having a thickness of about 1.1 mm. This substrate is referred to as a transfer stamper. A signal pit layer formed on the transfer stamper is referred to as a transfer information surface.

A first reflective film is formed on the surface of the first substrate that includes pits by sputtering. The first reflective film constitutes a first information surface.

A sheet substrate that has a thickness of about 0.1 mm and is substantially transparent to reproduction light and the transfer information surface of the transfer stamper are bonded together with a UV curable resin. The thickness of the sheet substrate can be other than the above value.

Next, the transfer stamper is separated from the bonding surface of the UV curable resin. The UV curable resin can peel off at the interface with the transfer stamper because of its excellent releasability from the resin substrate. Upon removal of the transfer stamper, the shape of the transfer information surface is transferred to the UV curable resin so that transfer pits are formed on the sheet substrate. A second reflective film that is translucent to reproduction light is formed on the transfer pits by sputtering. Thus, a second information surface is provided on the sheet substrate.

Subsequently, the first information surface of the first substrate and the second information surface of the sheet substrate are bonded together with a UV curable resin. Thus, a single-sided two-layer disk is produced that can be read from the sheet substrate side.

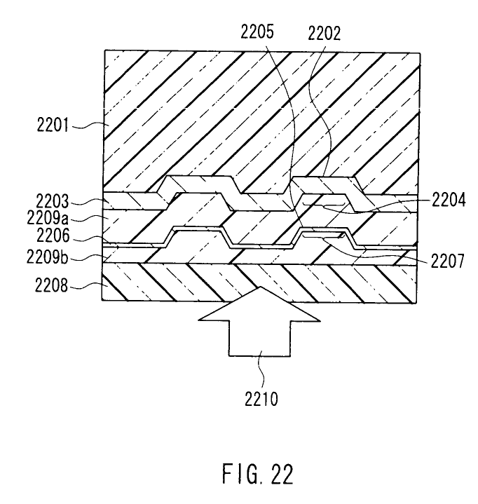

FIG. 22 is a schematic cross-sectional view showing the two-layer disk. Reference numeral 2201 denotes a first substrate, 2202 denotes first signal pits, 2203 denotes a first reflective film, 2204 denotes a first information surface, 2205 denotes transfer pits, 2206 denotes a second reflective film, 2207 denotes a second information surface, 2208 denotes a sheet substrate, 2209a and 2209b denote a UV curable resin, and 2210 denotes a reproduction laser beam.

As shown in FIG. 22, the pit shape of the first information surface that is detected from the reproduction light side can be identified as the pit shape of the first reflective film. Therefore, the pits of the first information surface are made smaller than the first pits formed by injection molding due to the presence of the reflective film. The second reflective film is translucent and has a thickness so that the quantity of light reflected from the first information surface is substantially equal to that reflected from the second information surface. In this embodiment, the thickness of the second reflective film is about 20 nm. The pit shape of the second information surface can be identical to the transfer pit shape. Thus, the transfer information surface of the transfer stamper should be recorded so that the transfer pit shape is substantially the same as the pit shape of the first reflective film formed on the first pits of the first substrate.

For the disk in FIG. 22, the protruding and receding directions of the transfer pits are reversed when viewed from the reproduction light side, as compared with the transfer pits in Embodiments 4 to 6. However, the conditions of forming the first reflective film, the viscosity of a resin, and the recording conditions of the transfer stamper are the same as those in Embodiments 4 to 6.

This embodiment describes experiments on the two-layer disk. However, the optimization of pit shape for each layer in Embodiment 7 also can be applied to a multilayer disk. The multilayer disk is produced in the following manner: information surfaces are stacked on a sheet substrate by repeating the transfer of a transfer information surface of at least one type of transfer stamper to the sheet substrate, and a first substrate is bonded to the sheet substrate provided with the information surfaces.

Embodiment 8

Embodiment 8 provides a multilayer read-only disk by using a chemically amplified resist and an electron beam recording apparatus. The multilayer disk is reproduced by a blue-purple laser having a reproduction wavelength of about 400 nm and has a storage capacity of 20 GB or more per layer.

A method for producing an optical disk of Embodiment 8 will be described below. FIGS. 23A to 23D show the method.

First, the chemically amplified resist is applied to a silicon wafer master. The resist-coated silicon wafer is baked and placed in the electron beam recording apparatus, where multipulse signal recording is performed in the same manner as Embodiment 1. The resist master is exposed, post-exposure baked (PEB), and developed to form a concave/convex pattern on the surface.

Next, a metal thin film such as nickel is sputtered on the resist pattern, and then is plated to a thickness of about 0.3 mm by using the metal thin film as an electrode. The resultant metal plate is separated from the resist master, cleaned to remove the resist material that adheres on the surface, and subjected to a drilling process. Thus, a metal stamper for injection molding is produced. Using the metal stamper with an injection molding machine, a resin is molded into a first substrate 2301 having a thickness of about 1.1 mm. The resin thickness can be other than this value.

Another silicon wafer coated with a chemically amplified resist is prepared. The silicon wafer is exposed and recorded in the electron beam recording apparatus to produce a resist master. The recording conditions will be described in detail later.

A metal stamper is produced from the resist master by the above method. Using the metal stamper with an injection molding machine, a resin is molded into a resin substrate 2302 having a thickness of about 1.1 mm. This substrate is referred to as a transfer stamper. A signal pit layer formed on the transfer stamper is referred to as a transfer information surface 2304.

A first reflective film 2303 is formed on the surface of the first substrate that includes pits by sputtering. The first reflective film constitutes a first information surface 2305 (FIG. 23A).

The first information surface 2305 of the first substrate and the transfer information surface 2304 of the transfer stamper are bonded together with a UV curable resin 2306 (FIG. 23B). In this embodiment, the UV curable resin is used directly between the information surfaces. However, the transfer information surface 2304 may be coated with the UV curable resin and bonded to the first substrate with a different adhesive.

Next, the transfer stamper is separated from the bonding surface of the UV curable resin. The UV curable resin can peel off at the interface with the transfer stamper because of its excellent releasability from the resin substrate. Upon removal of the transfer stamper, the shape of the transfer information surface is transferred to the UV curable resin so that transfer pits 2307 are formed on the first information surface 2305 (FIG. 23C).

A second reflective film 2308 that is translucent to reproduction light is formed on the transfer pits by sputtering. The second reflective film constitutes a second information surface 2309 (FIG. 23D).

Subsequently, a sheet substrate 2310 having a thickness of about 0.1 mm is bonded on the second information surface with a UV curable resin by spin coating. Thus, a single-sided two-layer disk is produced that can be read from the sheet substrate side. The thickness of the sheet substrate can be other than the above value.

FIG. 13 is a schematic cross-sectional view showing the two-layer disk. Reference numeral 1301 denotes a first substrate, 1302 denotes first signal pits, 1303 denotes a first reflective film, 1304 denotes a first information surface, 1305 denotes transfer pits, 1306 denotes a second reflective film, 1307 denotes a second information surface, 1308 denotes a sheet substrate, 1309a and 1309b denote a UV curable resin, and 1310 denotes a reproduction laser beam.

The disk thus produced is considered to have the following problems.

When the production process of an optical disk includes: using a transfer stamper that has a transfer information surface 2304 in which a signal pattern including concave pits is formed; transferring the signal pattern to a UV curable resin; and forming transfer pits 2307 (1305) in the information surface, the shape of the transfer pits may be changed significantly from that of the pits (with different lengths and widths) of the transfer information surface depending on the state of transfer to the resin.

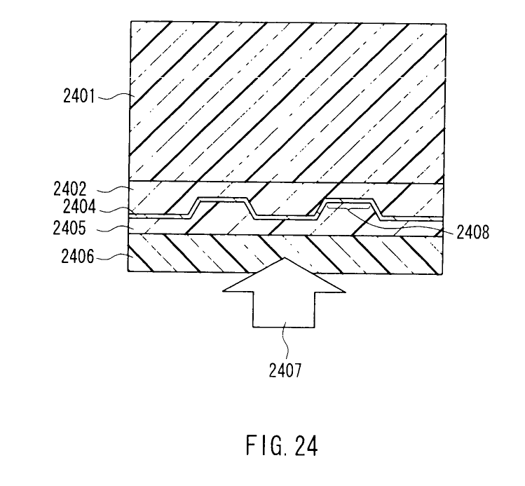

Such a change in transfer pit shape is not limited to the two-layer disk (FIG. 13), but is caused even in a signal-layer disk (FIG. 24). In the single-layer disk, as shown in FIG. 24, a transfer stamper having a transfer information surface that includes concave pits is transferred to a UV resin, thus forming an information surface.

The disk in FIG. 24 is produced in the following manner: a base substrate 2401 and a transfer stamper having the transfer information surface that includes concave pits are bonded together with a UV resin 2402, and the transfer stamper is removed to form an information surface 2408.

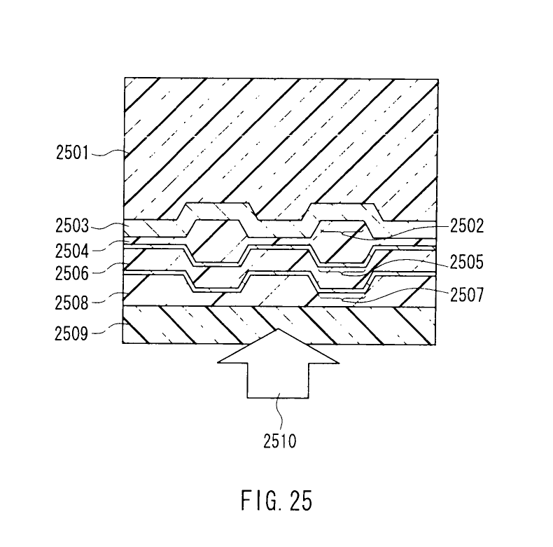

The above change in transfer pit shape also is caused in a multilayer disk as shown in FIG. 25. In the multilayer disk, a transfer stamper including concave pits is transferred to a UV resin, thus forming information surfaces.

The disk in FIG. 25 is produced in the following manner: a first substrate 2501 is produced by the method described in FIG. 23, the first substrate 2501 and a transfer stamper having the transfer information surface that includes concave pits are bonded together with a UV curable resin 2504, the transfer stamper is removed to form transfer pits 2505, another transfer stamper is bonded on the transfer pits 2505 with a UV curable resin 2506, and the transfer stamper is removed to form transfer pits 2507. Here, reference numeral 2502 denotes first transfer pits.

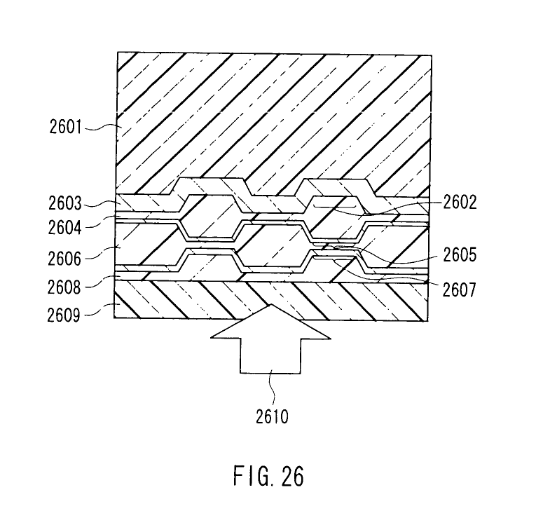

The above change in transfer pit shape also is caused in a multilayer disk as shown in FIG. 26.

The disk in FIG. 26 is produced in the following manner: a first substrate 2601 and a transfer stamper having the transfer information surface that includes concave pits are bonded together with a UV curable resin 2604, the transfer stamper is removed to form transfer pits 2605, a sheet substrate 2609 and another transfer stamper are bonded together with a UV curable resin 2608, the transfer stamper is removed to form transfer pits 2607, and the sheet substrate and the first substrate are bonded together with a UV curable resin 2606 so that the transfer pits 2605 are opposite to the transfer pits 2607.

As described above, when a disk has at least one information surface formed of transfer pits that are transferred from a transfer stamper having the transfer information surface that includes concave pits, the pit shape of the transfer information surface should be optimized in accordance with the transfer characteristics of a resin.

Next, the optimization of a transfer pit shape and the recording conditions of the transfer stamper will be described. The transfer stamper has a recording density of 25 GB. The track pitch is 0.32 μm, and the length of a 2T pit (the shortest pit) is 0.149 μm.

The transfer pit shape is evaluated by varying the viscosity of the UV resin. When the viscosity is more than 500 mPa·s, pits with a length of 2T are not transferred sufficiently, and almost no 2T pit is formed on the information surface. When the viscosity is less than 40 mPa·s, though the transfer characteristics are improved, the pit shape is distorted during removal of the transfer stamper, and the necessary pit shape cannot be achieved. In this embodiment, a UV curable resin having a viscosity of about 200 mPa·s is used to produce the two-layer disk.

The recording conditions of the transfer stamper will be described below.

The chemically amplified resist is applied to a silicon wafer master in a thickness of about 100 nm, and then is recorded in the electron beam recording apparatus.

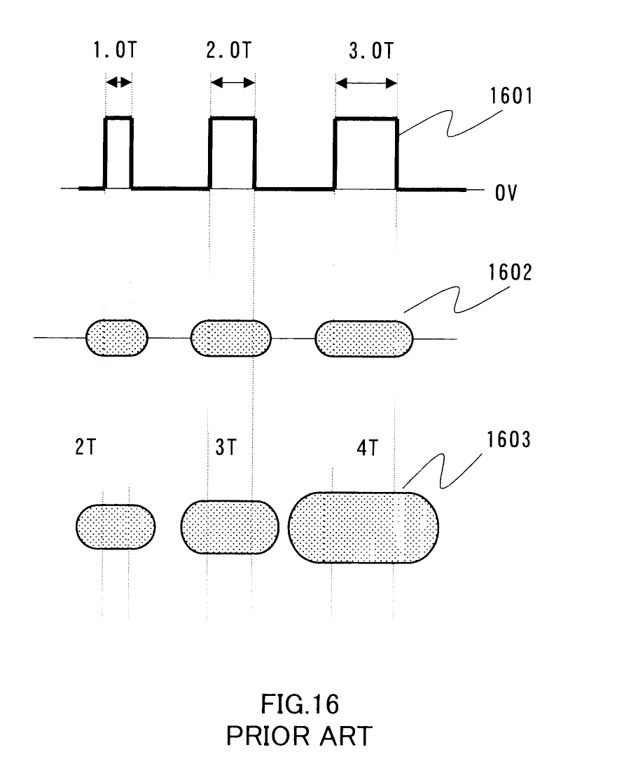

When one signal pit is recorded for one pulse such as a signal 1602 in FIG. 16, the actual exposure time to record the shortest pit (a first pit) 2T of the transfer pits should be reduced by half the 2T, i.e., about 1.0T. The reason for this is as follows: when a PEB temperature is about 20° C. higher than the standard specification temperature (130° C.) of the chemically amplified resist used so as to improve the shape of a pit edge, the length of the 2T pit is about two times longer than that of the exposed portion due to acid diffusion, and the pits are made smaller by the transfer to a UV resin. The 3T pit and the 4T pit are formed by the exposure to a 2.0T pulse and a 3.0T pulse, respectively. When these pits are recorded with a conventional signal as shown in FIG. 16, the width of the 3T pit is about 1.2 times that of the 2T pit, and the width of the 4T pit is about 1.5 times that of the 2T pit on the molded substrate. A transfer process is performed by using this transfer stamper with a UV curable resin having a viscosity of about 200 mPa·s to evaluate the shape of transfer pits. The results show that a difference in pit shape is further increased, and the width of the 2T pit (the shortest pit) is not more than 60% of the width of the other long pits.

Therefore, the pit shape of the transfer stamper should be recorded so as to correct a shape difference between the 2T pit and the long pits after the transfer to a UV resin.

As shown in FIG. 4, the multipulse converter 413 is used to convert the input information signal into a multipulse signal, and a voltage is applied to the electrode 406. The multipulse converter 413 performs the following conversion process. FIG. 17 shows the relationship between signal patterns before and after conversion and a pit shape to be formed. A signal 1701 represents an information signal pattern before conversion, which has been used for conventional recording. A signal 1702 represents a multipulse signal pattern obtained by conversion in the multipulse converter 413. Reference numeral 1703 denotes a pit shape to be formed.

The multipulse signal has been used to form pits by thermal recording, such as a recordable DVD. In the thermal recording, heat is conducted from the leading edge to the trailing edge of a pit. Therefore, the multipulse signal has an asymmetrical pattern with the pulse width being broader on the front side and narrower on the rear side. In the present invention, however, pits are formed by the acid diffusion from an exposed portion. Therefore, unlike the conventional pattern for thermal recording, a symmetrical pattern should be used so that the exposed portions at both ends of a pit exhibit symmetry.

The shortest 2T pit is recorded with a 1.0T pulse as described above, and the transfer pits are formed by the transfer to a UV resin, thus producing a disk. The measurement shows that the asymmetry of the 2T signal is about 8%.

The recording conditions of the pits greater than 2T are controlled. The width of the pits greater than 2T is adjusted to be substantially the same as that of the 2T pit, so that the transfer pits have the same width. The shift of each pit in the length direction is made by adjusting the multipulse signal.

The 3T pit has a symmetrical pattern that includes two pulses with substantially the same length: a front pulse 1704 and a rear pulse 1705. Asymmetric behavior is evaluated by setting the length from the leading edge of the front pulse to the trailing edge of the rear pulse to 2.0T and varying the widths of the front pulse and the rear pulse. FIG. 18 plots the asymmetric behavior of the 3T signal against the front and the rear pulse width. When the front pulse has a width of 0.8T, the asymmetry is about 8% and agrees with the asymmetry of the 2T signal. When the front pulse has a width of not less than 1.0T (corresponding to about 100% of an exposure pulse for the 2T pit), the asymmetry is about 15%, and the deviation of the pit length from the 2T pit becomes prominent. Thus, jitter is increased to 7% or more and not suitable for practical use. When the front pulse has a width of not more than 0.5T (corresponding to about 50% of an exposure pulse for the 2T pit), a space between the front pulse and the rear pulse is too large to record the middle of a pit on the transfer information surface. Consequently, the pit is split into two parts.

For the 4T pit, a pattern includes a front end pulse 1706, a rear end pulse 1707, and an intermediate pulse 1708 arranged between the front and the rear end pulse. The front end pulse 1706 and the rear end pulse 1707 have substantially the same length, and the intermediate pulse 1708 has a cycle T. As with the 3T pit, the widths of the front end pulse and the rear end pulse are determined by the asymmetric behavior during reproduction of the transfer pits. When the front and the rear end pulse have a width of not less than 1.0T (corresponding to about 110% of an exposure pulse for the 2T pit), the asymmetry is 15% or more, and the deviation of the pit edge from the 2T or 3T signal becomes prominent. Thus, the jitter value is increased to 7% or more and not suitable for practical use. When the front and the rear end pulse have a width of not more than 0.35T (corresponding to about 40% of an exposure pulse for the 2T pit), the pit edge is tapered, and the jitter value is increased to 7% or more.

A duty ratio of the intermediate pulse is changed to evaluate the pit shape. When the duty ratio is not less than 65%, the width of the 4T pit is about 1.4 times that of the 2T pit after transfer. Therefore, this duty ratio is not effective for multipulse recording. When the duty ratio is not more than 45%, the long pit is not exposed sufficiently in the middle and thus is split.

As shown in FIG. 19, a pattern in which the spacing between pulses does not reach the low level also can have the multipulse recording effect. When the spacing is at the low level and the duty ratio is about 50%, a favorable pit shape can be achieved as described above. Even if the spacing is not at the low level, but at a level of not more than about 50% of the high level, as indicated by a signal 1902 in FIG. 19, the similar pit shape can be achieved. However, the spacing at a level of not less than 50% leads to a significant difference in width between the long pit and the short pit and is not effective for multipulse recording.

The following method can be used to establish the conditions to obtain good jitter properties.

The pit length can be adjusted by shifting the positions of a front pulse and a rear pulse toward the center by the same amount. In this embodiment, e.g., when both front pulse and rear pulse of the 3T pit are 0.85T, the front pulse is shifted backward by about 0.02T and the rear pulse is shifted forward by about 0.02T. As a result, the asymmetry can be corrected to about 8%. Even if the length of the front pulse differs from that of the rear pulse, the asymmetry can be corrected in the same manner. Moreover, the shift directions of the pulses may be reversed, that is, the front pulse is shifted forward and the rear pulse is shifted backward.

For the pits greater than 3T, the front end pulse and the rear end pulse are shifted forward and backward respectively by the same amount, so that the reproduction jitter can be improved by about 1%. In this case, the shift directions of the pulses may be reversed, that is, the front end pulse is shifted backward and the rear end pulse is shifted forward.

The scanning electron microscope (SEM) observation of a transfer pit shape provided in Embodiment 8 shows that the width of the pits greater than 2T is substantially the same as that of the 2T pit.

It is most difficult to transfer the shortest pit. This embodiment uses the shortest pit having a length of 0.149 μm. When the length is less than 0.1 μm, the transfer characteristics of the UV curable resin becomes extremely poor, and the pit hardly can be transferred. When the length is not less than 0.3 μm, a difference in transfer characteristics between long and short pits becomes smaller, and the effect of the present invention is reduced.

The reproduction characteristics of the disk thus produced are evaluated by using a reproduction wavelength of 405 nm, a reproduction linear velocity of 4.9 m/s, and a random pattern measured with a Limit equalizer. The results show that each layer has good reproduction characteristics, and the jitter is about 5%.

To study the PEB conditions, a pit shape of the transfer stamper is evaluated by increasing/decreasing a temperature from the PEB temperature inherent in the resist used. Lower temperatures can reduce the amount of acid diffusion, so that a variation in width and length of short and long pits is reduced, while edge distortion is increased. The similar edge distortion is observed also after transfer. Particularly when the temperature is not more than the standard specification temperature, the jitter value is degraded and not suitable for practical use. Higher temperatures can reduce the edge distortion. However, when the temperature is more than a given temperature, the resist material deteriorates to cause pit shape variations. In the case of the chemically amplified resist “UV3,” the resist is used in the range of the standard specification temperature (130° C.) to the deterioration temperature (250° C.), thereby producing a master without any problem.

In this embodiment, a disk that includes only pit trains is produced and evaluated. However, the same process can be used for a disk that includes pits, grooves, etc.

This embodiment describes experiments on the two-layer disk. However, a multilayer disk also can provide the same effect, in which layers having transfer pits are stacked in order by using a transfer stamper with a UV curable resin, and the pit shape of each layer can be optimized in the same manner.

Embodiment 8 employs an electron beam recording apparatus. The present invention also can provide the same effect, e.g., when applied to a recording apparatus that uses a chemically amplified resist or a laser beam recorder (LBR) that uses a far-ultraviolet laser and a chemically amplified resist.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A method for manufacturing an optical disk master comprising:
forming a resist layer by application of a chemically amplified resist;
converting an information signal into a multipulse signal having a symmetrical shape;
exposing the resist layer in accordance with the multipulse signal;
heat-treating the resist layer; and
developing the resist layer to form signal pits.

2. The method according to claim 1, wherein the multipulse signal comprises:
one pulse for a first pit that is the shortest pit of the signal pits;
two pulses for a second pit that is the second shortest pit, the two pulses comprising a front pulse and a rear pulse that have substantially the same length;
three pulses for a third pit that is the third shortest pit, the three pulses comprising a front end pulse, a rear end pulse, and an intermediate pulse arranged between the front end pulse and the rear end pulse, the front end pulse and the rear end pulse having substantially the same length, and the intermediate pulse having the same cycle as that of a clock signal of the information signal; and
pulses for pits more than the third pit, in which the number of intermediate pulses is increased one by one.

3. The method according to claim 2, wherein the first pit is a 2T pit.

4. The method according to claim 3, wherein a pulse width of the front pulse and the rear pulse is 60% to 130% of a pulse that corresponds to the first pit.

5. The method according to claim 3, wherein a pulse width of the front end pulse and the rear end pulse is 40% to 130% of a pulse that corresponds to the first pit.

6. The method according to claim 3, wherein a pulse width of the front pulse and the rear pulse is 60% to 130% of a pulse that corresponds to the first pit, and a pulse width of the front end pulse and the rear end pulse is 40% to 130% of the pulse that corresponds to the first pit.

7. The method according to claim 2, wherein the first pit is a 3T pit.

8. The method according to claim 7, wherein a pulse width of the front pulse and the rear pulse is 60% to 80% of a pulse that corresponds to the first pit.

9. The method according to claim 7, wherein a pulse width of the front end pulse and the rear end pulse is 40% to 100% of a pulse that corresponds to the first pit.

10. The method according to claim 7, wherein a pulse width of the front pulse and the rear pulse is 60% to 80% of a pulse that corresponds to the first pit, and a pulse width of the front end pulse and the rear end pulse is 40% to 100% of the pulse that corresponds to the first pit.

11. The method according to claim 1, wherein the multipulse signal comprises:
one pulse for a first pit that is the shortest pit of the signal pits;
two pulses for a second pit that is the second shortest pit, the two pulses comprising a front pulse and a rear pulse that have substantially the same length;
two pulses for a third pit that is the third shortest pit, the two pulses comprising a front end pulse and a rear end pulse that have substantially the same length;
three pulses for a fourth pit that is the fourth shortest pit, the three pulses comprising a front end pulse, a rear end pulse, and an intermediate pulse arranged between the front end pulse and the rear end pulse, the front end pulse and the rear end pulse having substantially the same length, and the intermediate pulse having the same cycle as that of a clock signal of the information signal; and
pulses for pits more than the fourth pit, in which the number of intermediate pulses is increased one by one.

12. The method according to claim 11, wherein the first pit is a 3T pit.

13. The method according to claim 12, wherein a pulse width of the front pulse and the rear pulse is 60% to 80% of a pulse that corresponds to the first pit.

14. The method according to claim 12, wherein a pulse width of the front end pulse and the rear end pulse is 90% to 110% of a pulse that corresponds to the first pit.

15. The method according to claim 12, wherein a pulse width of the front pulse and the rear pulse is 60% to 80% of a pulse that corresponds to the first pit, and a pulse width of the front end pulse and the rear end pulse is 90% to 110% of the pulse that corresponds to the first pit.

16. The method according to claim 2, wherein a duty ratio of the intermediate pulse is 45% to 65%.

17. The method according to claim 2, wherein an output level of a spacing between the front pulse and the rear pulse or a spacing between the front end pulse and the rear end pulse is not more than 50% of an maximum output of each pulse.

18. The method according to claim 2, wherein positions of the front pulse and the rear pulse are shifted backward and forward or forward and backward respectively by substantially the same amount so that the second pit has an optimum length.

19. The method according to claim 2, wherein positions of the front end pulse and the rear end pulse are shifted backward and forward or forward and backward respectively by substantially the same amount so that the signal pits more than the second pit have an optimum length.

20. The method according to claim 2, wherein positions of the front pulse and the rear pulse are shifted backward and forward or forward and backward respectively by substantially the same amount so that the second pit has an optimum length, and positions of the front end pulse and the rear end pulse are shifted backward and forward or forward and backward respectively by substantially the same amount so that the signal pits more than the second pit have an optimum length.

21. The method according to claim 1, wherein the exposed resist master is heated at a temperature in a range of a thermosetting temperature to a thermal decomposition temperature of the resist.

22. The method according to claim 1, wherein an electron beam recording apparatus is used for exposure and recording.

23. A method for manufacturing an optical disk comprising:
forming a transfer stamper having a transfer information surface on at least one side, the transfer information surface being formed of a signal layer including at least concave pits;
bonding a base substrate and the transfer stamper together so that the transfer information surface is opposed to the base substrate with a photocurable resin in contact with the transfer information surface; and
transferring the transfer information surface of the transfer stamper to the photocurable resin while removing the transfer stamper at an interface with the photocurable resin,
wherein the transfer stamper is formed so that a width of each pit of a transferred information surface is substantially the same.

24. The method according to claim 23, wherein the optical disk comprises a first substrate as the base substrate, the first substrate has a first information surface on one side, and the first information surface is formed of a first signal layer including at least pits and a first reflective film, and
wherein the method further comprises:
forming at least one type of transfer stamper having a transfer information surface on at least one side, the transfer information surface being formed of a signal layer including pits;
bonding the first substrate and the transfer information surface of the transfer stamper together with the photocurable resin in contact with the transfer information surface; and
transferring the transfer information surface of the transfer stamper to the photocurable resin while removing the transfer stamper at the interface with the photocurable resin,
wherein when the transfer is performed at least one time by using the at least one type of transfer stamper on the first substrate, a pit shape of the first information surface is substantially the same as a pit shape of a transferred information surface.

25. The method according to claim 24, wherein the optical disk comprises a first substrate as the base substrate and a second substrate, the first substrate has a first information surface on one side, the first information surface is formed of a first signal layer including at least pits and a first reflective film, and the second substrate is made of a resin substantially transparent to reproduction light, and
wherein the method further comprises:
bonding the second substrate and the transfer information surface of the transfer stamper together with the photocurable resin in contact with the transfer information surface;
transferring the transfer information surface of the transfer stamper to the photocurable resin while removing the transfer stamper at the interface with the photocurable resin; and
bonding a transferred information surface of the second substrate and the first information surface of the first substrate together with a resin substantially transparent to reproduction light after the transfer is performed at least one time by using the at least one type of transfer stamper on the second substrate,
wherein the transfer stamper is formed so that a pit shape of the first information surface is substantially the same as a pit shape of the transferred information surface.

26. The method according to claim 23, wherein the photocurable resin has a viscosity of 40 mPa·s to 500 mPa·s.

27. The method according to claim 25, wherein the first reflective film has a thickness of 40 nm to 100 nm.

28. The method according to claim 25, wherein a width of pits except for the shortest pit of the transferred information surface is 70% to 95% of a width of pits except for the shortest pit of the first signal layer formed on the first substrate.

29. The method according to claim 23, wherein the transfer stamper is formed by using an optical disk master that is produced by:
forming a resist layer by the application of a chemically amplified resist to a substrate;
converting an information signal into a multipulse signal having a symmetrical shape;
exposing the resist layer in accordance with the multipulse signal;
heat-treating the resist layer; and
developing the resist layer to form signal pits.

30. The method according to claim 24, wherein density of the first signal layer is substantially the same as density of the transferred information surface.
